(19) United States
(12) Patent Application Publication
(10) Pub. No.: US 2011/0180484 A1
(43) Pub. Date: Jul. 28, 2011

(54) SEPARATION DEVICE WITH DUAL DRIVES AND A METHOD OF REDUCING DONUTTING IN A SEPARATION DEVICE

(75) Inventors: Ian Arbuthnot, Western Australia (AU); Richard Triglavcanin, Western Australia (AU); Jeffrey Victor Belke, Western Australia (AU)

(73) Assignee: OUTOTEC OYJ, Espoo (FI)

(21) Appl. No.: 13/063,747

(22) PCT Filed: Sep. 16, 2009
(86) PCT No.: PCT/AU2009/001224

§ 371 Date: Mar. 11, 2011

(30) Foreign Application Priority Data
Sep. 17, 2008 (AU) 2008904842

(51) Int. Cl. B01D 21/18; B01D 21/00

(52) U.S. Cl. 210/738; 210/173

(57) ABSTRACT

The invention provides a separation device (20) for separating pulp from a feed material, the separation device comprising a tank (1) for receiving the feed material, a rake assembly (21) mounted for rotation within the tank (1) to move pulp towards an outlet (22) thereof and a shearing device (23) for shearing pulp within the tank (1), the shearing device (23) being mounted for movement independently of the rake assembly (21). The invention also provides a method for reducing donutting in a separation device (20).

### FIELD OF THE INVENTION

The present invention relates to separation devices for suspensions and pulps and in particular to a separation device comprising a device for shearing pulp. It has been developed primarily for use in thickeners and will be described hereinafter with reference to this application. However, it will be appreciated that the invention is not limited to this particular field of use.

### BACKGROUND OF THE INVENTION

The following discussion of the prior art is intended to present the invention in an appropriate technical context and allow its significance to be properly appreciated. Unless clearly indicated to the contrary, however, reference to any prior art in this specification should not be construed as an admission that such art is widely known or forms part of common general knowledge in the field.

Separation devices, such as thickeners, clarifiers and concentrators, are typically used for separating solids from suspensions (typically containing solids suspended in a liquid) and are often found in the mining, mineral processing, food processing, sugar refining, water treatment, sewage treatment, and other such industries. These devices typically comprise a tank in which solids are deposited from a suspension or solution and settle toward the bottom as pulp or sludge to be drawn off from below and recovered. A dilute liquor of lower relative density is thereby displaced toward the top of the tank, for removal via an overflow launder. The suspension to be thickened is initially fed through a feed pipe, conduit or line into a feedwell disposed within the main tank. A rake assembly is conventionally mounted for rotation about a central drive shaft and typically has at least two rake arms having scraper blades to move the settled material inwards for collection through an underflow outlet.

In its application to mineral processing, separation and extraction, a finely ground ore is suspended as pulp in a suitable liquid medium such as water at a consistency which permits flow, and settlement in quiescent conditions. The pulp is settled from the suspension by a combination of gravity with or without chemical and/or mechanical processes. Initially, coagulant and/or flocculant can be added into the suspension to improve the settling process. The suspension is then carefully mixed into the separation device, such as a thickener, to facilitate the clumping together of solid particles, eventually forming larger denser “aggregates” of pulp particles that are settled out of suspension. Liquid, also known as liquor, is typically trapped with the solid particles within the pulp aggregates.

Typically, several zones or layers of material having different overall densities gradually form within the tank, as illustrated in FIG. 1A. At the bottom of the tank 1, the pulp forms a relatively dense zone 2 of compacted pulp or solids 3 that are frequently in the form of networked aggregates (i.e. the pulp aggregates are in continuous contact with one another). This zone 2 is typically called a “pulp bed” or a networked layer of pulp. Above the pulp bed 2, a hindered zone 4 tends to contain solids 5 that have not yet fully settled or “compacted”. That is, the solids or aggregates 5 are not yet in continuous contact with one another (un-networked). Above the hindered zone 4 is a “free settling” zone 6, where solids or aggregates 7 are partially suspended in the liquid and descending toward the bottom of the tank 1. It will be appreciated that the hindered zone 4 is not always a distinct zone between the networked layer 2 and the free settling zone 6. Instead, the hindered zone 4 may form a transition or an interface between the networked layer 2 and the free settling zone 6 that blends between the two zones. Above the free settling zone 6 is a clarified zone 8 of dilute liquor, where little solids are present and the dilute liquor is removed from the tank 1 by way of an overflow launder (not shown). FIG. 1A also illustrates the feedwell 9 and underflow outlet 10 for removing the compacted pulp 3 from the tank 1.

It has hitherto been conventionally thought that to ensure that an appropriate underflow density is maintained within the pulp bed 2, it and the hindered zone 4 should be undisturbed to permit settling of the dense aggregates of solid particles into their desirable compacted arrangement. As a consequence, most developments in separation device technology concern the improvement of the settling process, either in the feedwell or the free settling zone 6, rather than any processes which may disturb the compacted arrangement of the solids particles in the pulp bed 3 or the partially compacted solids in the hindered zone 4.

It has also been found that as the pulp bed 2 increases in depth, it becomes increasingly difficult for released liquid to permeate through the pulp bed 2 and migrate upwardly into the clarified zone 8. One solution has been to provide dewatering pickets mounted to the rake arms to aid removal of such liquid, thereby increasing the underflow density and thus the efficiency of the separation process. These pickets are typically arranged at equally spaced intervals to produce dewatering channels in the pulp bed equally spaced across the diameter of the tank, and are designed to minimise disturbance of the pulp bed.

It has also been found that the rotation of the rake assembly, with or without pickets, increases the possibility of pulp bed rotation, which is also known as “donutting”. Donutting occurs where discrete agglomerated masses of pulp particles, referred to as “donuts” or “islands”, form around the rake assembly, causing an increase in the torque required to rotate the rake assembly and a decreased active cross-sectional area for separation. Hence, this results in a decrease in the density of the thickened pulp. In the case of a rake assembly, the agglomerated masses tend to accumulate around the rake arms and pickets, and thus tend to rotate with the rotation of the rake assembly. In donutting, the whole of the thickened pulp bed does not necessarily rotate when an agglomerated mass forms, nor does the rest of the contents of the thickening tank—only the agglomerated mass actually rotates. As a consequence, this phenomenon detrimentally affects thickener performance and efficiency in three primary ways. Firstly, the accumulation of agglomerated masses around the rake assembly impedes the formation of the desired bed of relatively uniform thickened pulp and decreases the active cross-sectional areas for separation, thus reducing the pulp density, or underflow density. Secondly, the increased torque that is required to rotate the rake assembly increases the wear on the drive assembly, hence increasing the frequency of maintenance and thus downtime for the thickener. Thirdly, donutting prevents the rake assembly from performing its primary function of raking the settled solids to the central discharge point.

Various solutions have been proposed for inhibiting or preventing donutting. One proposed solution has been the placement of stationary baffles or pickets to prevent the formation of agglomerated masses by breaking-up any such formations around the rake assembly.

It is an object of the invention to overcome or ameliorate one or more of the deficiencies of the prior art, or at least to provide a useful alternative.

### SUMMARY OF THE INVENTION

According to a first aspect, the invention provides a separation device for separating pulp from a feed material, the separation device comprising a tank for receiving the feed material, a rake assembly mounted for rotation within the tank to move pulp towards an outlet thereof and a shearing device for shearing pulp within the tank, the shearing device being mounted for movement independently of the rake assembly.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

By configuring the shearing device to move independently of the rake assembly, the shearing device is movable at a different speed and/or direction to the rake assembly. This creates a complex fluid motion and turbulence that inhibits or hinders the tendency of pulp to agglomerate around the shearing device and/or rake assembly, thus inhibiting or preventing the formation of donuts in the pulp bed. As a consequence, the separation efficiency of the separation device is improved, thereby increasing the underflow density of the recovered solids.

Preferably, the shearing device is movable in a different direction to the direction of rotation of the rake assembly. In one preferred form, the shearing device moves in an opposite direction to the direction of rotation of the rake assembly.

Preferably, the rake assembly is mounted to a first drive shaft for rotation about a first axis and the shearing device is mounted to a second drive shaft for rotation about a second axis. In one embodiment, the second axis is coincident with the first axis. In one preferred form, the second drive shaft is concentric to the first drive shaft. Alternatively, the second axis is parallel, eccentric or offset with respect to the first axis.

Preferably, the shearing device rotates at a different rotational speed to the rotational speed of the rake assembly.

Preferably, the shearing device counter-rotates with respect to the direction of rotation of the rake assembly.

Preferably, the shearing device is reversibly rotatable about the second axis. Preferably, the rotation of the shearing device is periodically reversible about the second axis.

Preferably, the second axis is movable relative to the first axis. Preferably, the second axis rotates, revolves or orbits at least partially around the first axis. In one preferred form, the second axis at least partially traverses a regular path around the first axis. In another preferred form, the second axis at least partially traverses an irregular path around the first axis. In some embodiments, the second axis moves in a circular path. In other embodiments, however, the second axis moves in a non-circular path, which may be geometrically regular or irregular.

Alternatively, the second axis is fixed relative to the first axis.

Preferably, the shearing device is rotatably mounted to a support, the support being disposed for movement at least partially about the first axis. More preferably, the support is rotatable about the first axis. In one embodiment, the first drive shaft movably drives the support. In another embodiment, the support is movably driven by a drive mechanism arranged at an outer edge of the tank, preferably a peripheral drive. In a further embodiment, the support is movably driven by a drive shaft concentric to the first drive shaft.

Preferably, the support is disposed adjacent the top of the tank. Alternatively, the support is disposed adjacent the bottom of the tank. In one embodiment, the support includes a service bridge extending radially from the first drive shaft above the tank.

In a further alternative, the rake assembly is mounted to a first drive shaft for rotation about a first axis and the shearing device is mounted to a second drive shaft for movement along or substantially parallel to the first axis. Preferably, the shearing device slidably moves along or parallel to the first axis. In one preferred form, the second drive shaft is concentric to the first drive shaft. Preferably, the shearing device moves substantially vertically with respect to a pulp bed. In one preferred form, the shearing device substantially reciprocates vertically.

Preferably, the first axis is a central axis of the tank.

Preferably, the separation device comprises a first drive mechanism for driving rotation of the first drive shaft. Preferably, the first drive mechanism comprises a single gearbox drive. Alternatively, the first drive mechanism comprises a single or multiple pinion drive. Other types of drives may be readily used for the first drive mechanism, for example, a hydraulic drive motor. Preferably, the first drive shaft is connectable to the second drive shaft to drive rotation of the shearing device.

Preferably, the separation device comprises a second drive mechanism independent of the first drive mechanism for driving movement of the second shaft. Preferably, the second drive mechanism comprises a single gearbox drive. Alternatively, the second drive mechanism comprises a single or multiple pinion drive. In one embodiment, the second drive mechanism comprises a peripheral drive. Other types of drives may be readily used for the second drive mechanism, for example, a hydraulic drive motor.

In one preferred form, the second drive mechanism comprises a drive mechanism arranged at an outer edge of the tank, preferably a peripheral drive mechanism. In another preferred form, the second drive mechanism is coaxial with the second drive shaft.

Preferably, the shearing device is disposed above the rake assembly. In one preferred form, the rake assembly is located adjacent the bottom of the tank.

Preferably, one or more shearing parameters are controlled with respect to a flux of the feed material fed into the tank and/or one or more operational parameters to controllably apply an optimal shear to pulp passing through a region of the tank. Throughout the description and claims, the term “flux” means the rate of flow of solids suspended in a fluid (generally a liquid) suspension and is measured in tonnes per square metre hour (t/m²h). In the context of minerals separation, the flux is used to refer to the suspended pulp solids in the slurry. Although the solids concentration or pulp density of the suspension may change as the pulp moves through the tank, the flow of solids may be regarded as being independent of the pulp density and is expressed as a flux.

Preferably, the shearing parameters are selected from the group consisting essentially of the speed of the shearing device, the shape of the shearing device and the depth of the shearing region.

Preferably, the operational parameters are selected from the group consisting essentially of the pulp composition, the pulp particle size, the pulp flow velocity in the tank, the pulp yield stress, the pulp viscosity, the underflow specific gravity, the underflow weight per weight percentage and the rate at which flocculant is added to the feed material.

Preferably, one or more of the shearing parameters are adjustable in response to changes in the flux and/or one or more of the operational parameters.

Preferably, the separation device comprises a flux sensor for monitoring the flux of the suspension. Preferably, the separation device comprises one or more sensors for monitoring one or more of the operational parameters. Preferably, the separation device comprises a control unit or system in communication with the flux sensor and/or the operational parameter sensors.

The inventors have also discovered unexpectedly and surprisingly that the application of a disturbance, preferably in the form of shear, to pulp can result in improved efficiency in the separation process, especially the settling process in a thickener. It is believed that by causing a disturbance substantially uniformly across the disturbance zone, the networked pulp in the disturbance zone is disrupted, by breaking up, disturbing, re-arranging, re-orienting, or “shaking” the continuous contact between the pulp, or subjecting it to a force. This disruption of the networked pulp in the disturbance zone enables the release of trapped liquid upwardly towards the clarified zone of dilute liquor and increases the density of the pulp below the disturbance zone relative to the pulp density above the disturbance zone.

Throughout the description and claims, the terms “disrupt”, “disrupting”, “disruption” and its variants are taken to mean breaking up, disturbing, re-arranging, re-orienting or “shaking” particles or a substance, as well as applying a force to the particles or substance. In the context of the present invention, these terms are taken to mean breaking up, disturbing, re-arranging, re-orienting, applying a force to, or “shaking” the organised structure of the networked pulp, including but not limited to the continuous contact between the networked pulp.

Preferably, the shearing device is at least partially submerged within a region of the tank. Preferably, the region comprises a portion of the hindered zone. More preferably, the region comprises a lower portion of the hindered zone. Alternatively, the region comprises a portion of the pulp bed (networked pulp layer). In one preferred form, the region comprises only an upper portion of the pulp bed (networked pulp layer). In another particularly preferred form, the region comprises only the upper half of the pulp bed (networked pulp layer). In a further alternative, the region comprises portions of the hindered zone and the pulp bed (networked pulp layer). In one embodiment, the region comprises the hindered zone and the pulp bed (networked pulp layer).

It is further preferred in one embodiment that the shearing device applies shear substantially uniformly across a disturbance zone in an upper region of a networked layer of pulp that has formed from pulp aggregates settling towards the bottom of the tank, so as to disrupt the networked pulp in the disturbance zone within a predetermined period of time. More preferably, the shearing device applies shear across the disturbance zone within the predetermined period of time.

Preferably, the predetermined period of time substantially corresponds to the time in which the networked pulp passes through the disturbance zone.

Preferably, the disturbance zone is within an upper 75% of the networked layer of pulp. More preferably, the disturbance zone is within an upper half of the networked layer of pulp. In one preferred form, the disturbance zone is within an upper 30% of the networked layer of pulp. In another preferred form, the disturbance zone is within an upper 10% of the networked layer of pulp. In a particularly preferred form, the disturbance zone is at or adjacent the top of the networked layer of pulp.

In one alternative form, the disturbance zone extends from the upper region of the networked layer of pulp to include a portion of the hindered zone. More preferably, the disturbance zone extends includes a lower portion of the hindered zone.

Preferably, the shear is such that the pulp below the disturbance zone reforms with a substantially higher density relative to the pulp above the disturbance zone. More preferably, the shear induces a stepwise increase in the density of the pulp below the disturbance zone. In one preferred form, the density of the pulp below the disturbance zone is at least 5% greater than the density of pulp above the disturbance zone. In another preferred form, the density of the pulp below the disturbance zone is at least 10% greater than the density of pulp above the disturbance zone. In a further preferred form, the density of the pulp below the disturbance zone is at least 25% greater than the density of pulp above the disturbance zone. In yet another preferred form, the density of the pulp below the disturbance zone is at least 35% greater than the density of pulp above the disturbance zone. In a particularly preferred form, the density of the pulp below the disturbance zone is at least 50% greater than the density of pulp above the disturbance zone.

Preferably, the disturbance zone comprises a proportion of the upper region of the networked pulp layer. More preferably, the disturbance zone comprises a proportional volume of the upper region.

Preferably, the disturbance zone at least partially comprises a cross-sectional area of the upper region. More preferably, the disturbance zone comprises at least 10% of the cross-sectional area of the upper region within the predetermined period of time. Even more preferably, the disturbance zone comprises at least 30% of the cross-sectional area of the upper region within the predetermined period of time. It is preferred that the disturbance zone comprises at least 50% of the cross-sectional area of the upper region within the predetermined period of time. It is further preferred that the disturbance zone comprises at least 70% of the cross-sectional area of the upper region within the predetermined period of time. In one preferred form, the disturbance zone comprises at least 80% of the cross-sectional area of the upper region within the predetermined period of time. In another preferred form, the disturbance zone comprises at least 90% of the cross-sectional area of the upper region within the predetermined period of time. In a particularly preferred form, the disturbance zone comprises substantially the entire cross-sectional area of the upper region within the predetermined period of time.

Preferably, the shearing device applies shear to at least a radial cross-section of the disturbance zone. More preferably, the shearing device moves at least partially through the radial cross-section of the disturbance zone. Preferably, the shearing device applies shear to at least a diametrical cross-section of the disturbance zone. More preferably, the shearing device moves at least partially through the diametrical cross-section of the disturbance zone.

Preferably, the shearing device is movable at least partially within the disturbance zone such that a substantially uniform cumulative shear is applied to the networked pulp in the disturbance zone within the predetermined period of time. Throughout the description and the claims, the term “cumulative shear” means the sum of the shear that is applied to a typical pulp aggregate or particle passing through a defined region. In this context, the cumulative shear is the total sum of shear that a typical pulp aggregate or particle experiences between its entry into and exit from the disturbance zone, which is determined by the sum of “shear” events that have occurred and the magnitude of those shear events; that is, the number of times the typical pulp aggregate or particle has been “hit” (a shear force has been applied to it). These shear events not only include direct “hits” of the pulp aggregate or particle by the shearing device but also disturbances or “shaking” of the pulp aggregate or particle caught in the wake of the passage of the shearing device, which the inventors call a “zone of turbulence”. These zones of turbulence are sufficient to apply a shear force to the pulp aggregate or particle, albeit less than the amount of shear directly applied by the shearing device.

Preferably, the shearing device moves within the disturbance zone. More preferably, the shearing device rotates within the disturbance zone.

Preferably, the shearing device comprises at least two shearing arms supported for movement within the disturbance zone. In one preferred form, the shearing device comprises at least three shearing arms supported for rotation within the disturbance zone. More preferably, the shearing device comprises a plurality of shearing elements for applying shear to the networked pulp. Preferably, the shearing elements each define a zone of turbulence for disrupting the networked pulp.

Preferably, two or more shearing elements are spaced apart along at least one arm of the shearing device to define respective intervals therebetween, such that a substantially uniform average shear is applied in at least two intervals, along a line parallel to or coincident with the at least one arm. More preferably, the average shear in all the intervals between the shearing elements along the line is substantially uniform or the same. Throughout the description and the claims, the term “average shear” means the average of shear applied to pulp between any two predetermined reference points. In this context, the two reference points typically (but not necessarily) coincide with adjacent shearing elements disposed on the at least one arm of the shearing device. It will be appreciated that the line may be non-linear in whole or part. For example, the line may include a portion that is arcuate, angled or offset with respect to a straight portion of the line. In one preferred form, the line is a radial line.

Preferably, the shearing device applies a substantially uniform number of shear events to the networked pulp in the disturbance zone within the predetermined period of time.

Preferably, the shearing device applies a combination of at least two of substantially uniform average shear, substantially uniform cumulative shear and a substantially uniform number of shear events. More preferably, the shearing device applies a substantially uniform average shear, substantially uniform cumulative shear and a substantially uniform number of shear events to the networked pulp.

In one preferred form, the shearing device comprises at least two outwardly extending arms. Preferably, one or more shearing elements are disposed on the arms. Preferably, the shearing elements apply shear along the arms. Preferably, the shearing device applies substantially uniform average shear along the length of the arms. Preferably, the arms extend radially outwardly substantially to an outer perimeter of the disturbance zone.

Preferably, the arms are movable in a direction substantially parallel to the second axis. Preferably, the arms are pivotally or hingedly mounted to the second drive shaft. More preferably, the arms substantially reciprocate.

In another preferred form, one or more shearing elements are disposed along the second axis to extend radially outwardly. Preferably, one or more shearing elements are removably mountable on the second drive shaft. More preferably, the shearing device comprises a collar for removably mounting the one or more shearing elements on the second drive shaft.

Preferably, two or more shearing elements are arranged asymmetrically about the second axis.

Preferably, one or more shearing elements are spaced at uneven intervals with respect to each other. Preferably, the uneven intervals progressively increase from the second axis to an outer edge of at least one arm. As a result, the number of the shearing elements progressively decreases from the second axis to an outer edge of at least one arm. In one preferred form, the uneven intervals are respectively proportional to the radial distances from the second axis to the shearing elements.

Preferably, the shearing elements define a tapered profile of the shearing device. More preferably, the shearing elements progressively decrease in length from the second axis to an outer edge of at least one arm.

Preferably, one or more shearing elements progressively decrease in thickness from the second axis to an outer edge of at least one arm.

Preferably, one or more shearing elements extend at an angle of inclination with respect to a vertical plane. In one preferred form, the vertical plane is parallel to the arm. In another preferred form, the vertical plane is at right angles to the arm. Preferably, the angle of inclination is between 30° and 50°, and most preferably around 45°. Preferably, the angle of inclination is adjustable. Preferably, one or more shearing elements are hingedly or pivotally mounted to the arms to adjust the angle of inclination. Preferably, one or more shearing elements are supported by one or more angled arms extending from the first drive shaft.

Preferably, one or more shearing elements are substantially linear in shape. Alternatively, one or more shearing elements have a non-linear configuration. For example, the shearing element(s) may be helical, spiral or curved, in whole or part. In preferred embodiments, the shearing elements are formed from rods, pickets, blades, bars, wires, chains, sheets, plates, screen elements or mesh elements.

Preferably, the shearing device comprises at least one partially planar plate having a plurality of openings. In one preferred form, the at least one partially planar plate is to mounted to the second drive shaft for substantially slidable movement along or parallel to the second axis. More preferably, the at least one partially planar plate has a shape complementary to a horizontal cross-section of the tank. In a particularly preferred form, the plate is a horizontal disc. Preferably, the openings are evenly spaced with respect to one another. Preferably, the openings are substantially uniform in size.

In another preferred form, the at least one partially planar plate is mounted to the second drive shaft for rotation about the second axis. Preferably the at least one partially planar plate is arranged to be substantially vertical. Preferably, one or more openings progressively increase in size from the second axis to an outer edge of the at least one partially planar plate. Preferably, one or more openings are substantially aligned.

Preferably, the shearing device comprises a plurality of shearing elements arranged in a pattern. In one preferred form, two or more shearing elements are interconnected to form a mesh-like pattern. The mesh-like pattern may be partially or fully geometrical, and preferably comprises rectangular, square, diamond, triangular, hexagonal or other polygonal shapes. In another preferred form, two or more shearing elements form one or more geometrical shapes. Preferably, the geometrical shapes are complementary in shape. Preferably, the geometrical shapes form a web-like pattern. Preferably, the geometrical shapes comprise rectangular, square, diamond, triangular, hexagonal or other polygonal shapes.

Preferably, the separation device comprises a plurality of said shearing devices.

Preferably, the separation device is a thickener.

According to a second aspect of the invention, there is provided a method of reducing donutting in a separation device comprising a tank, a rake assembly mounted for rotation within the tank to move pulp towards an outlet thereof and a shearing device for shearing pulp within the tank, the method comprising the step of mounting the shearing device for movement independently of the rake assembly.

Preferably, the method comprises moving the shearing device in a different direction to the direction of the rake assembly. In one preferred form, the method comprises moving the shearing device in an opposite direction to the direction of rotation of the rake assembly.

Preferably, the method comprises mounting the rake assembly to a first drive shaft for rotation about a first axis and mounting the shearing device to a second shaft for rotation about a second axis. In one embodiment, the second axis is coincident with the first axis. In one preferred form, the method comprises disposing the second drive shaft concentrically with respect to the first drive shaft. Alternatively, the second axis is parallel, offset or eccentric to the first axis.

Preferably, the method comprises the step of the rotating the shearing device at a different rotational speed to the rotational speed of the rake assembly.

Preferably, the method comprises the step of counter-rotating the shearing device with respect to the direction of rotation of the rake assembly.

Preferably, the method comprises the step of reversibly rotating the shearing device about the second axis. Preferably, the method comprises the step of periodically reversing rotation of the shearing device about the second axis.

Preferably, the method comprises the step of moving the second axis relative to the first axis. More preferably, the second axis rotates, revolves or orbits at least partially around the first axis. In one preferred form, the second axis at least partially traverses a regular path around the first axis. Alternatively, the second axis at least partially traverses an irregular path at least partially around the first axis. In some embodiments, the second axis moves in a circular path. In other embodiments, however, the second axis moves in a non-circular path, which may be geometrically regular or irregular.

Alternatively, the method comprises the step of fixing the second axis relative to the first axis.

Preferably, the method comprises rotatably mounting the shearing device to a support and disposing the support for movement about the first axis. More preferably, the method comprises rotating the support about the first axis. In one embodiment, the first drive shaft extends axially through the tank to movably drive the support. In another embodiment, the support is movably driven by a drive mechanism arranged at an outer edge of the tank, preferably a peripheral drive mechanism. In a further embodiment, the support is movably driven by a drive shaft concentric to the first drive shaft.

Preferably, the method comprises disposing the support adjacent the top of the tank. Alternatively, the method comprises disposing the support adjacent the bottom of the tank. In one embodiment, the support comprises a service bridge extending radially from the first drive shaft above the tank.

In a further alternative, the method comprises mounting the rake assembly to a first drive shaft for rotation about a first axis and mounting the shearing device to a second shaft for movement along or parallel to the first axis. Preferably, the method comprises slidably moving the shearing device. In one preferred form, the method comprises disposing the second drive shaft concentrically to the first drive shaft. Preferably, the method comprises the step of moving the shearing device substantially vertically with respect to the pulp bed. In one preferred form, the method comprises the step of substantially reciprocating the shearing device vertically.

Preferably, the first axis is a central axis of the tank.

Preferably, the method comprises the step of providing a first drive mechanism to drive rotation of the first drive shaft. Preferably, the method comprises the step of connecting the first drive shaft to the second drive shaft. Preferably, the first drive mechanism comprises a single gearbox drive. Alternatively, the first drive mechanism comprises a single or multiple pinion drive. Other types of drives may be readily used for the first drive mechanism, for example, a hydraulic drive motor.

Preferably, the method comprises the step of providing a second drive mechanism independent of the first drive mechanism to drive movement of the second drive shaft. In one preferred form, the method comprises the step of arranging the second drive mechanism at an outer edge of the tank, and is preferably a peripheral drive mechanism. In another preferred form, the method comprises the step of arranging the second drive mechanism coaxially to the second drive shaft for moving the shearing device. Preferably, the second drive mechanism comprises a single gearbox drive. Alternatively, the second drive mechanism comprises a single or multiple pinion drive. In one embodiment, the second drive mechanism comprises a peripheral drive. Other types of drives may be readily used for the second drive mechanism, for example, a hydraulic drive motor.

Preferably, the method comprises the step of disposing the shearing device above the rake assembly. In one preferred form, the rake assembly is located adjacent the bottom of the tank.

Preferably, the method further comprises submerging the shearing device within a region of the tank. Preferably, the region comprises a portion of the hindered zone. More preferably, the region comprises a lower portion of the hindered zone. Alternatively, the region comprises a portion of the pulp bed (networked pulp layer). In one preferred form, the region comprises only an upper portion of the pulp bed (networked pulp layer). In another particularly preferred form, the region comprises only the upper half of the pulp bed (networked pulp layer). In a further alternative, the region comprises portions of the hindered zone and the pulp bed (networked pulp layer). In one embodiment, the region comprises the hindered zone and the pulp bed (networked pulp layer).

It is further preferred in one embodiment that the method comprises moving the shearing device so that it applies shear substantially uniformly across a disturbance zone in an upper region of a networked layer of pulp that has formed from pulp aggregates settling towards the bottom of the tank, so as to disrupt the networked pulp in the disturbance zone within a predetermined period of time.

Preferably, the disturbance zone is within an upper 75% of the networked layer of pulp. More preferably, the disturbance zone is within an upper half of the networked layer of pulp. In one preferred form, the disturbance zone is within an upper 30% of the networked layer of pulp. In another preferred form, the disturbance zone is within an upper 10% of the networked layer of pulp. In a particularly preferred form, the disturbance zone is at or adjacent the top of the networked layer of pulp.

In one alternative form, the disturbance zone extends from the upper region of the networked layer of pulp to include a portion of the hindered zone. More preferably, the disturbance zone extends includes a lower portion of the hindered zone.

Preferably, the predetermined period of time substantially corresponds to the time in which the networked pulp passes through the disturbance zone.

Preferably, the disturbance is such that the pulp below the disturbance zone reforms with a substantially higher density relative to the pulp above the disturbance zone. More preferably, the disturbance induces a stepwise increase in the density of the pulp below the disturbance zone. In one preferred form, the density of the pulp below the disturbance zone is at least 5% greater than the density of pulp above the disturbance zone. In another preferred form, the density of the pulp below the disturbance zone is at least 10% greater than the density of pulp above the disturbance zone. In a further preferred form, the density of the pulp below the disturbance zone is at least 25% greater than the density of pulp above the disturbance zone. In yet another preferred form, the density of the pulp below the disturbance zone is at least 35% greater than the density of pulp above the disturbance zone. In a particularly preferred form, the density of the pulp below the disturbance zone is at least 50% greater than the density of pulp above the disturbance zone.

Preferably, the disturbance zone comprises a proportion of the upper region of the networked pulp layer. More preferably, the disturbance zone comprises a proportional volume of the upper region.

Preferably, the disturbance zone at least partially comprises a cross-sectional area of the upper region. More preferably, the disturbance zone comprises at least 10% of the cross-sectional area of the upper region within the predetermined period of time. Even more preferably, the disturbance zone comprises at least 30% of the cross-sectional area of the upper region within the predetermined period of time. It is preferred that the disturbance zone comprises at least 50% of the cross-sectional area of the upper region within the predetermined period of time. It is further preferred that the disturbance zone comprises at least 70% of the cross-sectional area of the upper region within the predetermined period of time. In one preferred form, the disturbance zone comprises at least 80% of the cross-sectional area of the upper region within the predetermined period of time. In another preferred form, the disturbance zone comprises at least 90% of the cross-sectional area of the upper region within the predetermined period of time. In a particularly preferred form, the disturbance zone comprises substantially the entire cross-sectional area of the upper region within the predetermined period of time.

Preferably, the method comprises moving the shearing device to apply shear to at least a radial cross-section of the disturbance zone. More preferably, the shearing device moves at least partially through the radial cross-section of the disturbance zone. Preferably, the method comprises moving the shearing device to apply shear to at least a diametrical cross-section of the disturbance zone. More preferably, the shearing device moves at least partially through the diametrical cross-section of the disturbance zone.

Preferably, the method comprises the steps of controlling one or more shearing parameters with respect to a flux of the feed material fed into the tank and/or one or more operational parameters to controllably apply an optimal shear to pulp passing through the region. Preferably, the method comprises the step of adjusting one or more of the shearing parameters in response to changes in the flux and/or one or more of the operational parameters.

Preferably, the shearing parameters are selected from the group consisting essentially of the speed of the shearing device, the shape of the shearing device and the depth of the shearing region.

Preferably, the operational parameters are selected from the group consisting essentially of the pulp composition, the pulp particle size, the pulp flow velocity in the tank, the pulp yield stress, the pulp viscosity, the underflow specific gravity, the underflow weight per weight percentage and the rate at which flocculant is added to the feed material.

Preferably, the method comprises the step of monitoring the flux of the feed material. Preferably, the method comprises the step of monitoring one or more of the operational parameters.

Preferably, the method comprises the step of moving the shearing device at least partially within the disturbance zone such that a substantially uniform cumulative shear is applied to the networked pulp in the disturbance zone within the predetermined period of time.

Preferably, the shearing device moves within the disturbance zone. More preferably, the shearing device rotates within the disturbance zone.

Preferably, the method comprises the steps of providing the shearing device with at least two shearing arms supported for movement within the disturbance zone and a plurality of shearing elements, and applying shear to the networked pulp. In one preferred form, the method comprises the steps of providing the shearing device with at least three shearing arms supported for rotation within the disturbance zone. Preferably, the method further comprises the step of providing a plurality of shearing elements for applying shear to the networked pulp. Preferably, the method comprises the step of defining a zone of turbulence with each shearing element for disrupting the networked pulp.

Preferably, the method further comprises the step of spacing apart two or more shearing elements along at least one arm of the shearing device to define respective intervals therebetween so that a substantially uniform average shear is applied to the pulp in at least two intervals along a line parallel to or coincident with the at least one arm. More preferably, the average shear in all the intervals between the shearing elements along the line is substantially uniform or the same. It will be appreciated that in the method, the line may be non-linear in whole or part. For example, the line may include a portion that is arcuate, angled or offset with respect to a straight portion of the line. In one preferred form, the line is a radial line.

In one preferred form, the method further comprises the step of providing the shearing device with at least two outwardly extending arms. Preferably, the method comprises applying substantially uniform average shear along the length of the arms. Preferably, the method comprises extending the arms radially outwardly substantially to an outer perimeter of the disturbance zone. Preferably, the method comprises the step of moving the arms in a direction substantially parallel to the second axis. Preferably, the method comprises the step of substantially reciprocating the arms.

Preferably, the shearing device applies a substantially uniform number of shear events to the networked pulp in the disturbance zone within the predetermined period of time.

Preferably, the shearing device applies a combination of at least two of substantially uniform average shear, substantially uniform cumulative shear and a substantially uniform number of shear events. More preferably, the shearing device applies a substantially uniform average shear, substantially uniform cumulative shear and a substantially uniform number of shear events to the networked pulp.

Preferably, the method comprises the step of disposing one or more shearing elements on the arms. Preferably, the method comprises arranging the shearing elements to apply shear along the arms.

Alternatively, the method comprises the step of disposing one or more shearing elements along the second axis to extend radially outwardly. Preferably, the method comprises the step of removably mounting the one or more shearing elements to the second drive shaft.

Preferably, the method further comprises the step of arranging two or more shearing elements asymmetrically about the second axis.

Preferably, the method further comprises the step of spacing one or more shearing elements at uneven intervals with respect to each other. Preferably, the method comprises spacing the shearing elements such that the uneven intervals progressively increase from the second axis to an outer edge of at least one arm. As a result, the number of the shearing elements progressively decreases from the second axis to an outer edge of at least one arm. In one preferred form, the uneven intervals are respectively proportional to the radial distances from the second axis to the shearing elements.

Preferably, the method comprises the step of defining a tapered profile of the shearing device with the shearing elements. More preferably, the method comprises progressively decreasing the length of the shearing elements from the second axis to an outer edge of at least one arm.

Preferably, the method comprises progressively decreasing the thickness of one or more shearing elements from the second axis to an outer edge of at least one arm.

Preferably, the method further comprises the step of extending the shearing elements at an angle of inclination with respect to a vertical plane. In one preferred form, the vertical plane is parallel to the arm. In another preferred form, the vertical plane is at right angles to the arm. Preferably, the angle of inclination is between 30° and 50°, and most preferably around 45°. Preferably, the method further comprises the step of adjusting the angle of inclination of the shearing elements. Preferably, the method further comprises the step of supporting the shearing elements from the first axis.

Preferably, the method comprises providing the shearing device with at least one partially planar plate having a plurality of openings. In one preferred form, the method comprises slidably moving the at least one partially planar plate. More preferably, the method comprises forming the at least one partially planar plate to have a shape complementary to a horizontal cross-section of the tank. In a particularly preferred form, the plate is a horizontal disc. Preferably, the method comprises evenly spacing the openings with respect to one another. Preferably, the openings are substantially uniform in size.

In another preferred form, the method comprises rotating the at least one partially planar plate about the second axis. Preferably the at least one partially planar plate is arranged to be substantially vertical. Preferably, the method comprises progressively increasing the size of one or more openings from the second axis to an outer edge of the at least one partially planar plate. Preferably, the method comprises substantially aligning one or more openings.

Preferably, the method comprises arranging a plurality of shearing elements into a pattern. In one preferred form, two or more shearing elements are interconnected to form a mesh-like pattern. The mesh-like pattern may be partially or fully geometrical, and preferably comprises rectangular, square, diamond, triangular, hexagonal or other polygonal shapes. In another preferred form, the method comprises arranging two or more shearing elements into one or more geometrical shapes. Preferably, the geometrical shapes are complementary in shape. Preferably, the geometrical shapes form a web-like pattern. Preferably, the geometrical shapes comprise rectangular, square, diamond, triangular, hexagonal or other polygonal shapes.

Preferably, the method comprises the step of providing a plurality of said shearing devices.

### BRIEF DESCRIPTION OF THE DRAWINGS

Preferred embodiments of the invention will now be described, by way of example only, with reference to the accompanying drawings in which:

FIG. 1A is a schematic cross-sectional view of the typical zones of material within a separation device;

FIG. 1B is a schematic cross-sectional view illustrating the settling process in the separation device of FIG. 1;

FIG. 1C is a schematic diagram illustrating a new method of improving the settling process;

FIG. 2A is a cross-sectional view of a separation device according to a first embodiment of the invention;

FIG. 2B is a plan view of the separation device illustrated in FIG. 2A;

FIG. 3 is a partial cross-sectional view of the drive assemblies for the shearing device and rake assembly of the separation device of FIG. 2;

FIG. 4 is a plan view of an alternative form of the drive assemblies for the shearing device and rake assembly of FIG. 3;

FIG. 5 is a cross-sectional view of the drive assemblies for the shearing device and rake assembly of FIG. 4 taken along the line 5-5;

FIG. 6 is a sectional view of the drive assemblies for the shearing device and rake assembly of FIG. 4, taken along the line 6-6;

FIG. 7 is a partial close-up sectional view of the epicyclic gearbox and pinion assembly for the shearing device and rake assembly of FIG. 4, taken from the circled area A of FIG. 6;

FIG. 8A is a cross-sectional view of a separation device according to a second embodiment of the invention;

FIG. 8B is a cross-sectional view of the shearing device of FIG. 8A;

FIG. 9 is a cross-sectional view of another shearing device for use in the separation device of FIG. 8A;

FIG. 10 is a cross-sectional view of a further shearing device for use in the separation device of FIG. 8A;

FIG. 11 is a cross-sectional view of yet another shearing device for use in the separation device of FIG. 8A;

FIG. 12A is a cross-sectional view of separation device according to a further embodiment of the invention;

FIG. 12B is a cross-sectional view of separation device according to yet another embodiment of the invention;

FIG. 12C is a cross-sectional view of separation device according to a further embodiment of the invention;

FIG. 13A is a cross-sectional view of a separation device according to a further embodiment of the invention;

FIG. 13B is a cross-sectional view of a separation device according to a further embodiment of the invention;

FIG. 14 is a plan view of a separation device according to a further embodiment of the invention;

FIG. 15A is a cross-sectional view of a separation device according to a further embodiment of the invention;

FIG. 15B is a plan view of the separation device of FIG. 15A;

FIG. 16 is a cross-sectional view of a separation device according to a further embodiment of the invention;

FIG. 17A is a plan view of a shearing device for use in the separation device of FIG. 16;

FIG. 17B is a front view of the shearing device illustrated in FIG. 17A;

FIG. 18A is a plan view of a shearing device for use in the separation device of FIG. 16;

FIG. 18B is a front view of the shearing device illustrated in FIG. 18A;

FIG. 19A is a plan view of a shearing device for use in the separation device of FIG. 16;

FIG. 19B is a front view of the shearing device illustrated in FIG. 19A;

FIG. 20A is a plan view of a shearing device for use in the separation device of FIG. 16;

FIG. 20B is a front view of the shearing device illustrated in FIG. 20A;

FIG. 21A is a plan view of a shearing device for use in the separation device of FIG. 16;

FIG. 21B is a front view of the shearing device illustrated in FIG. 21A;

FIG. 22A is a plan view of a shearing device for use in the separation device of FIG. 16;

FIG. 22B is a front view of the shearing device illustrated in FIG. 22A;

FIG. 23 is a schematic plan view of a separation device according to a further embodiment of the invention;

FIG. 24 is a schematic plan view of a separation device according to another embodiment of the invention;

FIG. 25 is a schematic cross-sectional view of a separation device according to further embodiment of the invention; and

FIG. 26 is a schematic cross-sectional view of a separation device according to another embodiment of the invention.

### PREFERRED EMBODIMENTS OF THE INVENTION

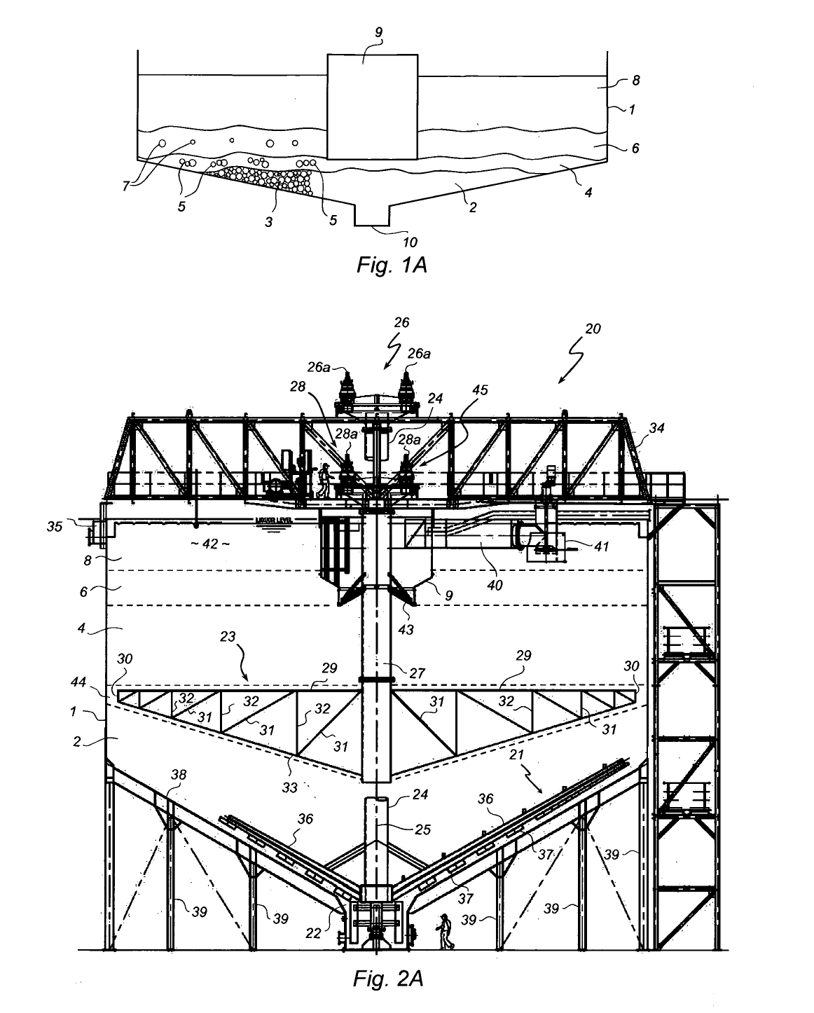

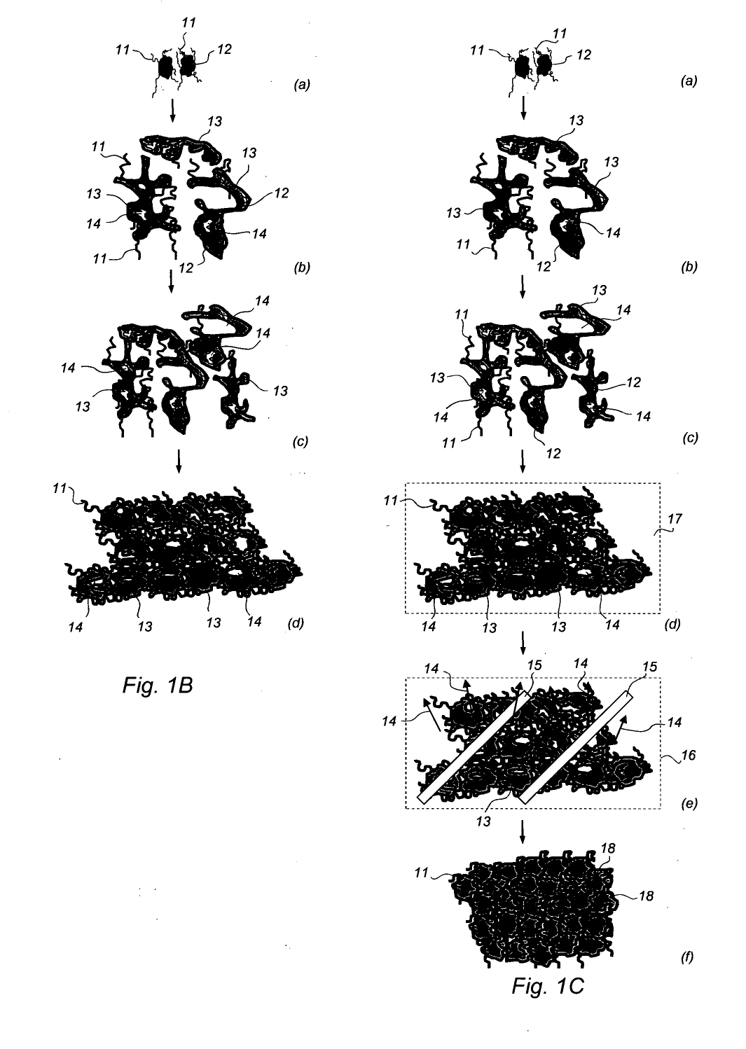

A preferred application of the invention is in the fields of mineral processing, separation and extraction, whereby finely ground ore is suspended as pulp in a suitable liquid medium such as water at a consistency which permits flow, and settlement in quiescent conditions. The pulp is settled from the suspension by a combination of gravity with or without chemical and/or mechanical processes. The pulp gradually clumps together to form aggregates of larger pulp particles as it descends from the feedwell towards the bottom of the tank. This process is typically enhanced by the addition of flocculating agents, also known as flocculants, which bind the settling solid or pulp particles together. These larger and denser pulp aggregates settle more rapidly than the individual particles by virtue of their overall size and density relative to the surrounding liquid, gradually forming a compacted arrangement within the pulp bed, as best shown in FIG. 1. Nevertheless, despite this compacted arrangement, it has been found that areas occur within the pulp bed where liquid remains trapped within and between the aggregates.

The settling of pulp as it passes through the zones in a thickening tank 1 is described in more detail with reference to FIG. 1B, where corresponding features have been given the same reference numerals. Within the feedwell 9, flocculant 11 is added and adsorbs onto discrete pulp particles 12, as best shown in FIG. 1B(a). The flocculant 11 and pulp particles 12 grow and loosely bind together into porous pulp aggregates 13 within the feedwell 9 and/or as the pulp particles 12 flow out of the feedwell 9 into the free settling zone 6, as best shown in FIG. 1B(b). Due to their porous nature, liquid 14 is trapped within individual pulp aggregates. As the pulp aggregates 13 further descend in the tank 1 through the free settling zone 6 and into the hindered zone 4, they become crowded and impede settling of each other, as best shown in FIG. 1B(c). Gradually, the pulp aggregates 14 consolidate and compact together into an organised networked layer 2 of pulp, also called a pulp bed, as best shown in FIG. 1B(d). Nevertheless, despite this compacted arrangement of the networked pulp layer 2, it has been found that areas occur within the networked pulp layer where liquid remains trapped within and between the aggregates in the networked layer of pulp. As it is difficult for this trapped liquid to escape the pulp bed into the clarified zone of dilute liquor, the underflow density of the pulp is diminished.

While this problem has been partially addressed in the prior art by the use of vertical rods mounted to the rake assembly to create dewatering channels for the escape of dilute liquor, this has been of limited effectiveness and has been found to cause further problems in the formation of donuts in the tank 1, especially in the pulp bed 2.

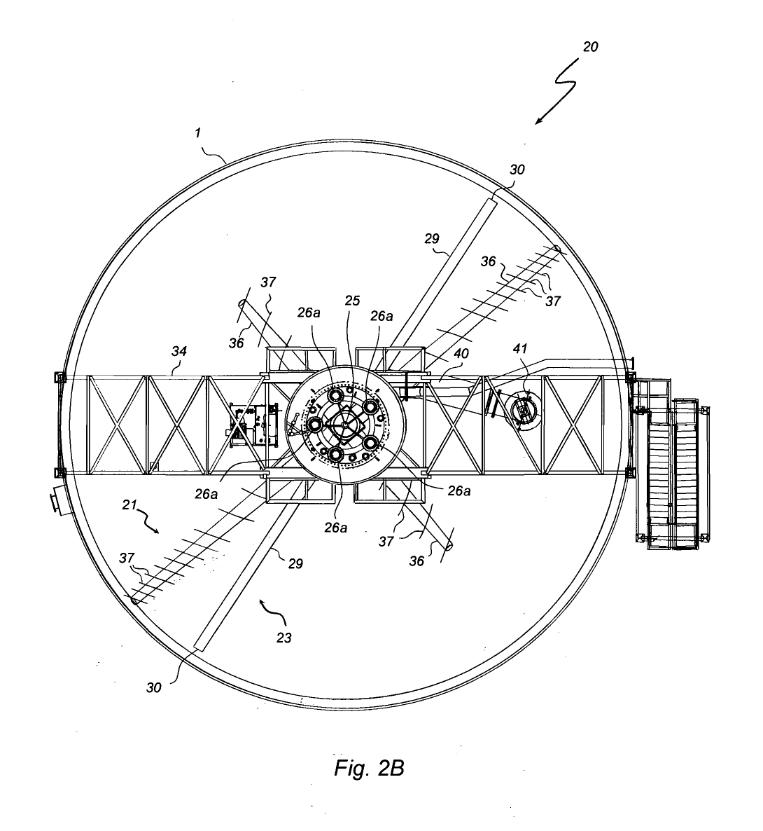

A first embodiment of the invention is illustrated in FIGS. 2A and 2B, where corresponding features have been given the same reference numerals. The separation device 20 for separating pulp from a feed material, in the form of a suspension, comprises a tank 1 for receiving the suspension and for containing a pulp bed 2. A rake assembly 21 is mounted for rotation within the tank 1 to move pulp towards an outlet 22 of the tank and a shearing device 23 for shearing pulp within the tank is mounted for movement independently of the rake assembly 21.

The rake assembly 21 is mounted to an inner drive shaft 24 for rotation about an axis 25 extending axially through the centre of the tank 1, and is driven by a peripheral drive assembly 26 comprising a number of pinion drives 26a, as best shown in FIG. 2B. The shearing device 23 is mounted to an outer concentric drive shaft 27 enclosing the inner drive shaft 24 for rotation about the same central axis 25 and is driven by its own drive assembly 28 comprising a number of pinion drives 28a separate to the drive assembly 26 (and its pinion drives 26a) for the rake assembly 21. In addition, the shearing device 23 has two outwardly extending radial arms 29 extending from the concentric drive shaft 27 to respective outer edges 30. A plurality of shearing elements in the form of angled linear rods or pickets 31 are mounted to each radial arm 29. The pickets 31 are inclined at an angle of approximately 45° with respect to a vertical plane perpendicular to the defined by the radial arms 29 at their respective points of connection, as best shown in FIG. 2A.

The pickets 31 are equispaced with respect to each other, and are connected to and supported by vertical posts 32, with a border 33 defining the shape of the radial arms 29. Alternatively, the pickets 31 may be spaced at uneven intervals with respect to each other.

In the first embodiment, the separation device 20 is configured as a bridge-type thickener, having a supporting bridge 34 located diametrically across and above the tank 1. The thickener 20 also has a feedwell 9 centrally located within the tank 1 and a circumferential overflow launder 35. The rake assembly 21 comprises rake arms 36 having scraper blades 37 extending downwardly towards the bottom 38 of the tank 1 to move settled and compacted pulp towards the underflow outlet 22. The entire tank 1 is supported by columns 39.

In operation, a suspension of pulp in the form of a slurry is fed into the feedwell 9 through a feed pipe or conduit 40. The slurry may be fed tangentially into the feedwell 9 to improve the residence time for mixing and reaction with reagents, such as flocculants, that help create the aggregates or “flocs” of higher density pulp solids. Tangential entry also assists in dissipating the kinetic energy of the slurry in the feedwell 9, thus promoting settling within the tank 1. A dilution apparatus 41 is connected to the feed pipe or conduit 40 of the feedwell 9 to dilute the slurry with dilute liquor 42 to assist flocculation and hence the settling process. The suspension then flows downwardly under gravity out of a restricted outlet 43 into the tank 1, where it settles to form the various zones of material, including the pulp bed 2, the hindered zone 4, free settling zone 6 and clarified zone 8. The relatively dense pulp bed 2 displaces the upper clarified zone 8 of relatively dilute liquor 42 towards the top of the tank 1. The rake assembly 21 is rotated by its associated drive shaft 24 about the central axis 25 so that the scraper blades 37 move the settled or thickened pulp towards the underflow outlet 22, from where it is drawn off for recovery, while the dilute liquor 42 is progressively drawn off through the overflow launder 35.

The drive assembly 28 drives the concentric drive shaft 27 with the pinion drives 28a and rotates the shearing device 23 around the tank 1 about the central axis 25. This causes the pickets 31 to apply a shear force to the pulp aggregates or particles descending from the feedwell outlet 43 into a shear region 44 in an upper region of the pulp bed 2. The shearing device 23 makes several passes through the shear region 44, applying shear several times to the pulp aggregates or particles before they exit the disturbance zone, either as direct “hits” from the pickets 31 or as disturbances in zones of turbulence associated with the wake of the passage of the pickets 31 through the shear region 44. The shearing device 23 may be rotated at a different rotational speed to the rake assembly 21, either in the same direction or the opposite direction to the direction of rotation of the rake assembly 21. The shearing device 23 may also be counter-rotated to the direction of rotation of the rake assembly 21, but at the same rotational speed as the rotational speed of the rake assembly.

Thus, the rake assembly 21 is able to perform its function of slowly rotating its arms 36 in the pulp bed 2 so that the scraper blades 37 direct settled pulp towards the underflow outlet 22, while the shearing device 23 can be rotated at a different rotational speed and/or direction to control the amount of shear that is applied to the pulp passing through the disturbance zone. Rotating the shearing device 23 at a different rotational speed and/or direction to the rake assembly 21 creates a complex fluid motion and added turbulence which disrupts or inhibits the formation of donuts within the pulp bed 2. In addition, the shear generated from the shearing device 23 tends to disrupt (by disturbing, re-arranging or breaking up) any larger pulp aggregates or particles that could agglomerate into a donut. Thus, the effects of donutting are minimised or prevented within the tank 1. Moreover, the shearing device 23 can be counter-rotated with respect to the rake assembly 21 to create a more complex fluid motion in the tank 1 to further disrupt the tendency of pulp aggregates to agglomerate into donuts. That is, rotating the shearing device 23 in the opposite direction to the direction of rotation of rake assembly 21 further reduces, minimises or prevents the occurrence of donutting in the pulp bed 2.

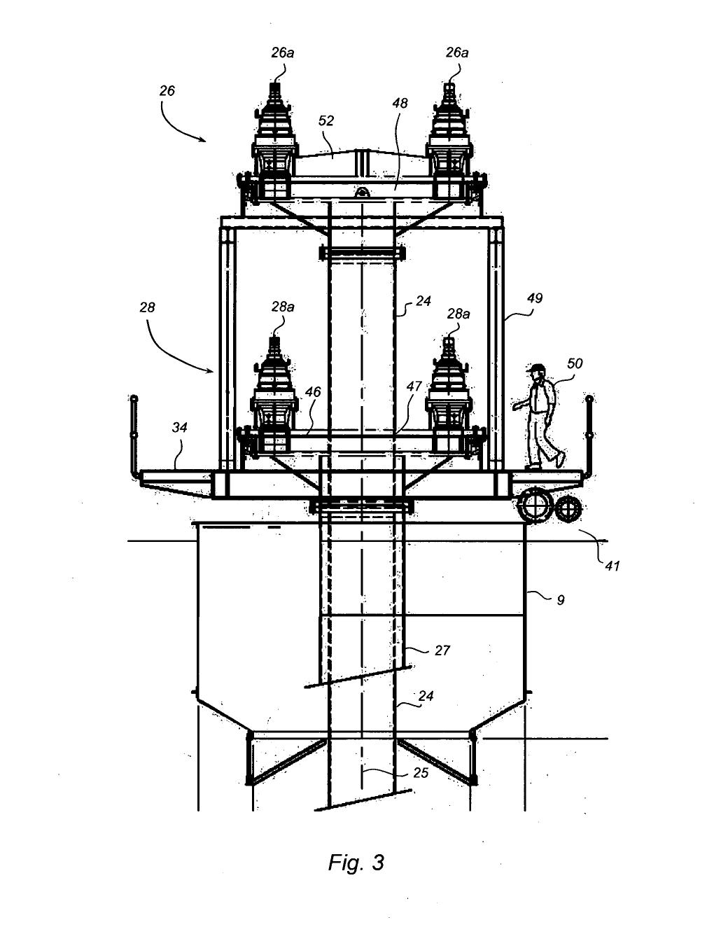

Referring to FIG. 3, the respective drive assemblies 26 and 28 for the rake assembly 21 and shearing device 23 are illustrated in more detail, where corresponding features have been given the same reference numerals. The shearing device drive assembly 28 comprises the concentric drive shaft 27 and pinion drives 28a, which are mounted on an annular support 46. An aperture 47 is formed in the annular support 46 to allow the inner drive shaft 24 of the rake assembly 21 to extend therethrough (so as to be substantially enclosed by the concentric drive shaft 27) and upwardly towards a drive shaft support 48. The annular support 46 is mounted on the bridge 34 and a cage-like housing 49 encloses the shearing device drive assembly 28. Personnel 50 are thus able to access the shearing device drive assembly 28 to perform maintenance and repair operations on the pinion drives 28a, the annular support 46 and the concentric drive shaft 27. The housing 49 also supports the rake drive assembly 26, which comprises the drive shaft support 48, the pinion drives 26a and a cover 52 for protecting the inner drive shaft 24.

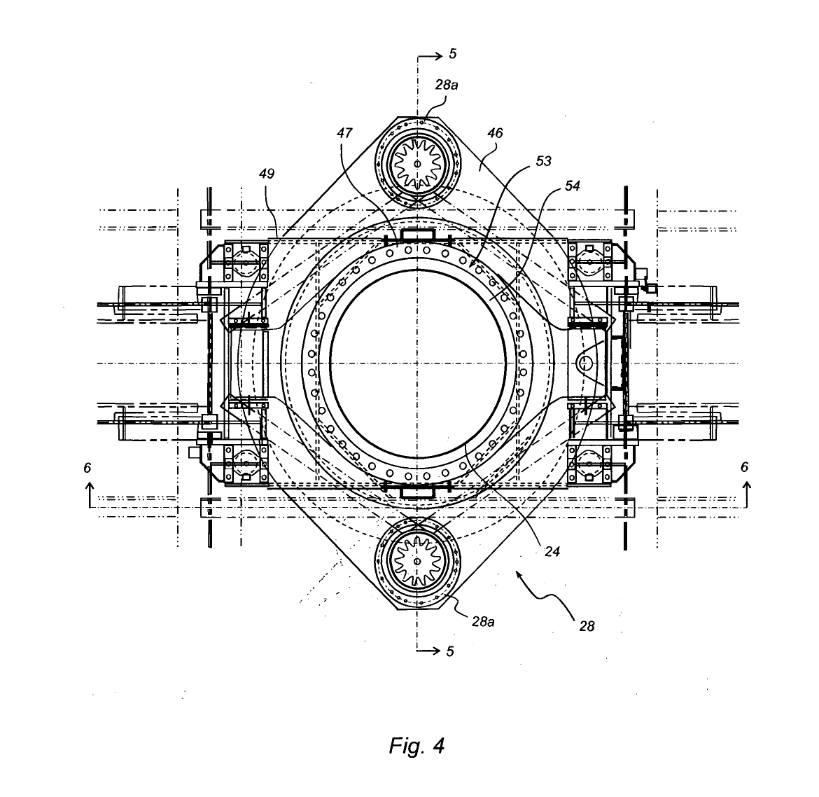

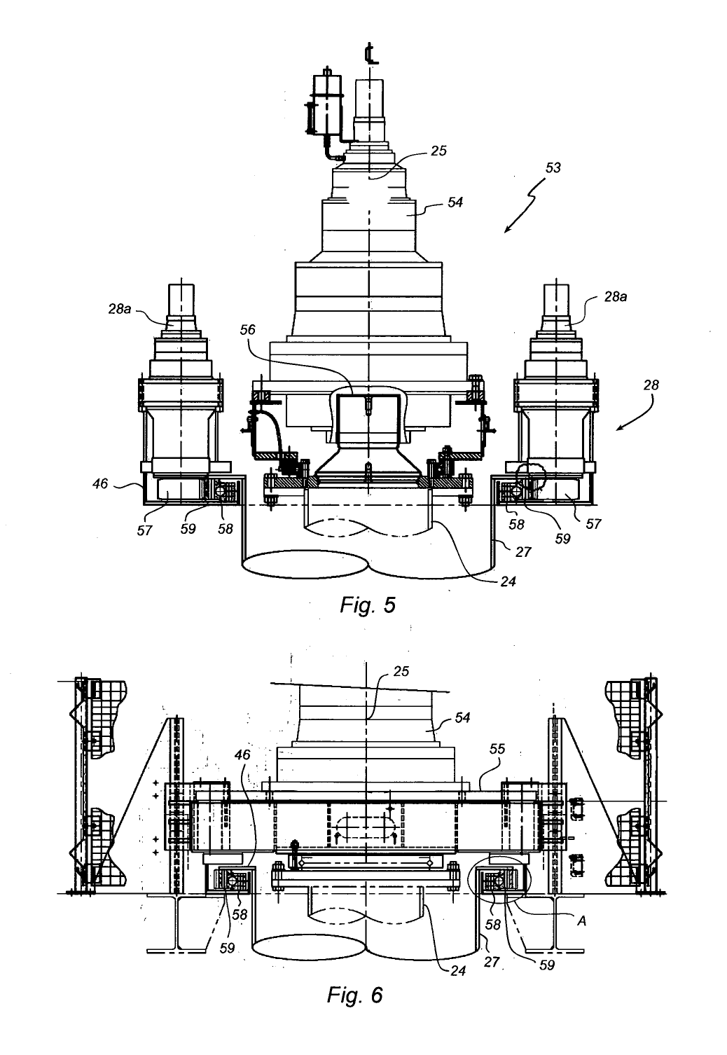

FIGS. 4 to 7, wherein corresponding features have been given the same reference numerals, illustrate an alternative embodiment of the drive assemblies 26 and 28 for the shearing device and rake assembly, respectively. In this embodiment, the shearing device drive assembly 28 comprises the annular support 46 and only two pinion drives 28a contained within the housing 49. The annular support 46 also has an aperture 47 for allowing the inner drive shaft 24 of the rake assembly 21 to extend therethrough, as described above. In this embodiment, the rake drive assembly 26 of FIG. 3 has been replaced with a drive assembly 53 comprising a single, central drive unit 54 coaxially connected to the inner drive shaft 24 of the rake assembly 21 at one end 56, as best shown in FIG. 5. The central drive unit 54 is mounted on an annular support 55 that is itself mounted on the annular support 46 of the shearing device drive assembly 28, as best shown in FIG. 6.

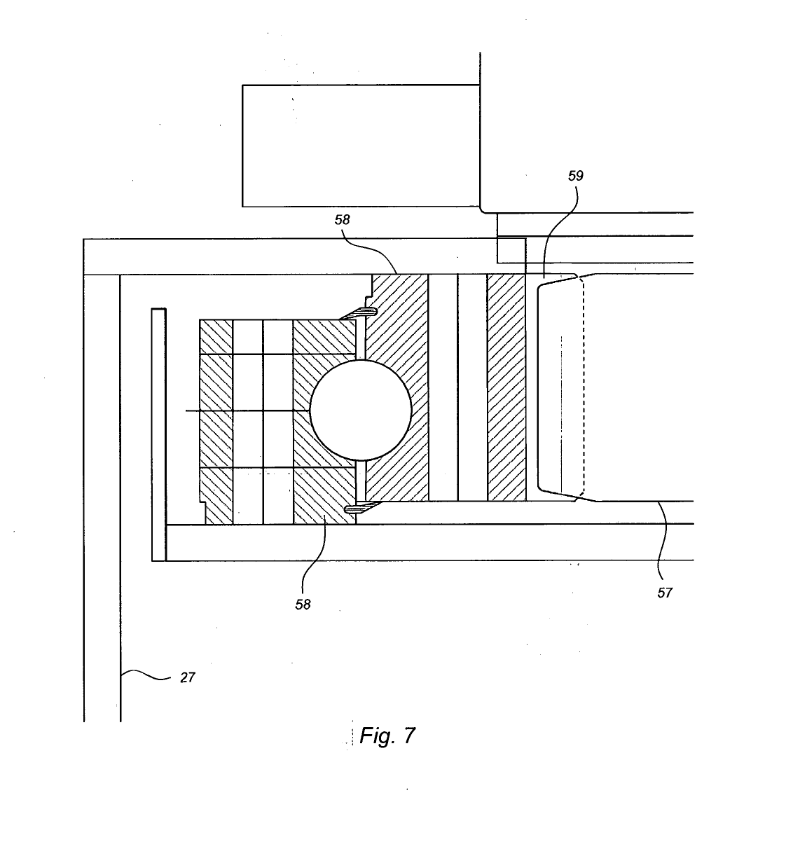

FIGS. 5 and 7 also illustrate the epicyclic gearbox and pinion gear assembly for the shearing device drive assembly 28. Each pinion drive 28a is connected to an associated pinion gear 57, which is connected to a geared slew ring 58 of the concentric drive shaft 27 via slew ring gear teeth 59. Thus, the pinion input drives 28a supply torque to the concentric drive shaft 27. The rotational speed of the concentric drive shaft 27 is thus a function of the drive speed of the pinion input drives 28a and the ratios of the pinion gear 57 and the geared slew ring 58.

The inventors have also unexpectedly and surprisingly found that by causing a disturbance to the networked layer of pulp, trapped liquid is released and the relative density of the disturbed pulp is increased, thus improving the settling efficiency of the separation device. In the case of FIG. 2A, the disturbance zone corresponds to the shear region 44.

The inventors have unexpectedly and surprisingly discovered that it is particularly advantageous for the shearing device 23 and its associated disturbance zone 44 to be located in the upper region, especially the upper half, of the pulp bed 2, as the liquid is readily able to escape the pulp bed 2 into the clarified zone 8 of dilute liquor. By way of contrast, applying a shear force in only the bottom half of the pulp bed 2 will release liquid upwardly, however, the undisturbed upper layer of the pulp bed tends to produce a blanketing effect that hinders or even prevents further upward migration of the liquid into the clarified zone 8. Thus, the improved efficiency attained by the shearing device 23 is not as effectively achievable in the bottom half of the pulp bed 2 as it is in the upper portion, particularly in the upper half. In addition, the shear applied to the disturbance zone 44 is not constrained by the need to minimise the rotation speed of the shearing device 23, as it has been unexpectedly and surprisingly found that a greater amount of shear produced by the increased rotational speed does not adversely affect the compaction of the pulp solids in the pulp bed 2. It has also been found that shearing in the top half of the pulp bed 2 in a counter-rotation with respect to the rotation of the rake assembly 21 at the bottom of the pulp bed further enhances donut minimisation and prevention.

The inventors also contemplate that this advantageous effect can be extended to the hindered zone 4 above the pulp bed 2, especially a lower portion of the hindered zone. That is, the shearing device 23 may be located only in the hindered zone 4, or both the networked pulp layer 2 and the hindered zone. For example, the shearing device 23 may be located so as to apply shear in an upper region of the networked pulp layer 2 and a lower portion of hindered zone. However, as stated above, the inventors have determined that the shearing device is ideally located in an upper region of the networked pulp layer 2, to obtain the most benefit of the invention's advantageous effects.

Furthermore, the inventors have unexpectedly and surprisingly found that the optimal disturbance for achieving this improved separation efficiency continuously over the work cycles of the separation device is obtained by causing the disturbance substantially uniformly across a disturbance zone in an upper region of the networked layer, as best shown in FIG. 1C where Corresponding features have been given the same reference numerals. As shown in FIGS. 1C(a) to 1C(d), flocculant is added into the feedwell 9 to adsorb onto discrete pulp particles 12 to promote the formation of aggregates 13 that descend and form a networked layer of pulp. Unlike the conventional settling process illustrated in FIG. 2A, where the pulp aggregates 13 are left alone during formation of the networked layer 2, a disturbance 15 is caused substantially uniformly across within a disturbance zone 16 in an upper region 17 of the networked layer 2, as best shown in FIG. 1C(e). As a consequence, a proportion of the networked pulp 3 (being the networked pulp that passes through the disturbance zone 16) is disrupted to release liquid 14 trapped within the networked pulp, thus increasing the relative density of the pulp 18 below the disturbance zone 16, as best shown in FIG. 1 C(f). In the case of FIG. 2A, the disturbance zone 16 corresponds to the shear region 44, which is in the upper region of the networked pulp layer 2.

In addition, as the depth of the networked pulp layer 2 increases to encompass the disturbance zone 44 as part of its upper region (around the upper 75% to 80% of the networked pulp layer 2), the shearing device 23 rotates around the tank 1, causing the pickets 31 to apply shear substantially uniformly across the disturbance zone 44 to the pulp aggregates or particles descending from the feedwell outlet 43 into the disturbance zone 44. As discussed above, the disruption of the networked pulp in the disturbance zone 44 results in the release of trapped liquid or liquor and increases the relative density of the pulp below the disturbance zone 44. The denser pulp below the disturbance zone 44 tends to reform a substantially higher density relative to the pulp above the disturbance zone, and thus settle quickly without excessive fractionation and detrimentally affect the settling process. The shear is applied either as direct “hits” from the pickets 31 or as disturbances in the zones of turbulence associated with the wake of the passage of the pickets 31 through the disturbance zone 44.

The disturbance or shear is preferably at least present in the disturbance zone 44 for a period of time in which the networked pulp passes through the disturbance zone, from entry to exit. It is preferred that in practice the disturbance is caused continuously in the disturbance zone during operation of the separation device over its work cycles to provide its advantageous and beneficial effects continuously for the entire period of the separation process. However, the disturbance may be limited to discrete time periods where desired.

The disturbance, preferably the application of shear, substantially uniformly across the disturbance zone 44 results in an increased probability of the networked pulp receiving a disturbance that disrupts its generally organised structure. The disturbance may also disrupt the continuous contact between the networked pulp. The disruption can take the form of shaking or disturbing the networked pulp. Alternatively, or cumulatively, the disruption can take the form of re-arranging, re-orienting or breaking up the networked pulp. In both cases, the disruption has the effect of releasing liquid trapped in the networked pulp, either between pulp aggregates or within a pulp aggregate. Thus, a substantial proportion of this trapped liquid is released upwardly out of the networked pulp bed 2. It is believed that the application of shear to the networked pulp “shakes”, re-arranges or breaks up its structure and/or continuous contact between the networked pulp so that the pulp below the disturbance zone becomes more dense, which results in an enhancement of their settling rate and/or their packing density. Moreover, the disturbance is not so excessive as to cause fractionation of the networked pulp into smaller pieces, which settle more slowly. The relatively denser pulp tends to reform into a networked pulp layer below the disturbance zone, due to its own weight applying compaction forces to the pulp. As a result, the invention provides the appropriate amount of disturbance to increase the settling rate and/or underflow density of the pulp in the networked layer or pulp bed 2, thus leading to increased efficiency and performance of the separation device. This improvement in the separation efficiency is in addition to the improvement in separation efficiency that is obtained from reducing or preventing the formation of donuts in the pulp bed.

It will be appreciated by those skilled in the art that the concept of causing a disturbance, for example by applying shear, in a disturbance zone in the networked layer 2, is contrary to conventional thought and has not been contemplated as such in the prior art. In the prior art, it was preferred not to disturb the pulp bed 2 or the hindered zone 4, since most of the aggregates are compacted or almost compacted (in the case of the hindered zone), and improvements were focussed on improving the efficiency of the settling process, either in the feedwell or in the free settling zone in the tank. This was reflected in the design of thickeners specifically to minimise motion within the pulp bed 2. For example, equally spaced predominantly vertically extending pickets were mounted on the rake arms to create vertical dewatering channels to release liquid. However, the configuration and spacing of the pickets were designed to ensure that the pickets moved gently through the pulp bed to minimise any turbulence created by the pickets or their associated dewatering channels.

The inventors have discovered that the disturbance, preferably by way of shear, induces a stepwise increase in the density of the pulp below the disturbance zone. In the context of the application of the invention to a thickening process, the inventors have found that by controlling the disturbance, preferably shear, to an optimal amount using at least one or more of three primary options that will be discussed in more detail below, this stepwise increase in density of the pulp below the disturbance zone is at least a 5% increase compared to the density of pulp above the disturbance zone. In one preferred form, there is at least a 10% increase compared to the density of pulp above the disturbance zone. In other preferred forms, the density of the pulp below the disturbance zone is at least 25%, preferably at least 35% and more preferably at least 50%, greater than the density of pulp above the disturbance zone.

The inventors have unexpectedly and surprisingly discovered that this improved settling effect is best achieved by carefully controlling the shear applied to the pulp bed so as to keep the shear at an optimum level, as distinct from a minimum level. If too much shear is applied, fractionation of the aggregates into smaller pieces occurs, resulting in the smaller pieces settling more slowly. Too little shear fails to disrupt the networked pulp sufficiently to release enough liquid to improve settling efficiency.

This optimal shear can be achieved in several ways. One way is to control one or more of the shearing parameters with respect to the flux of the feed material or suspension (the flow rate of solids suspended in a liquid, measured in tonnes per square metre hours (t/m²h) and/or one or more operational parameters. These shearing parameters comprise the shearing device speed (linear or rotational), the depth of the shear region (which would generally correspond to the disturbance zone 44) and the shearing device shape. The operational parameters are selected from the group consisting essentially of the pulp composition, the pulp particle size, the pulp flow velocity in the tank, the pulp yield stress, the pulp viscosity, the underflow specific gravity, the underflow weight per weight percentage and the rate at which flocculant is added to the feed material or suspension.

The specific shearing device configuration does not directly affect the optimal shear profile that is obtained from applying shear uniformly across the disturbance zone 44. It will be appreciated that the invention can thus be implemented to any shearing device employed in a separation device, and so is not limited to a particular shearing device configuration. However, another way of obtaining an optimal shear indirectly is through the specific configuration of the shearing device. The inventors have determined that there are several preferred configurations for the shearing device as they are generally more efficient in achieving an optimum shear profile, which are described below.

Thus, the inventors have discovered that the optimal amount of shear that results in improved and optimal thickener performance can be achieved primarily where the shearing device configuration results in at least one of, or a combination of, the following:

(1) a substantially uniform cumulative shear being applied to the networked pulp in the disturbance zone within the predetermined period of time;

(2) a substantially uniform average shear being applied to the networked pulp in at least two intervals between shearing elements spaced apart along at least one arm of the shearing device, along a line parallel to or coincident with the at least one arm; and

(3) a substantially uniform number of shear events being applied to the networked pulp in the disturbance zone within the predetermined period of time.

In relation to uniform average shear, it would be typical in most cases for the shearing device to employ two or more radially extending arms and thus the substantially uniform average shear applied in the intervals between the shearing elements will be along a radial line in alignment with the radial arms. In other words, the line along which the substantially uniform average shear is applied in the intervals generally corresponds to the profile of the shearing device when viewed in plan. However, it will be appreciated that where the shearing device is partially or fully non-linear in cross-section, the line will correspondingly be partially or fully non-linear in conformity with that cross-section of the shearing device. For example, the shearing device may have arms that are sinuous, partially curved or even zigzag-like in shape, in which case the substantially uniform average shear would be applied along a sinuous, partially curved or even zigzag-like line, respectively.

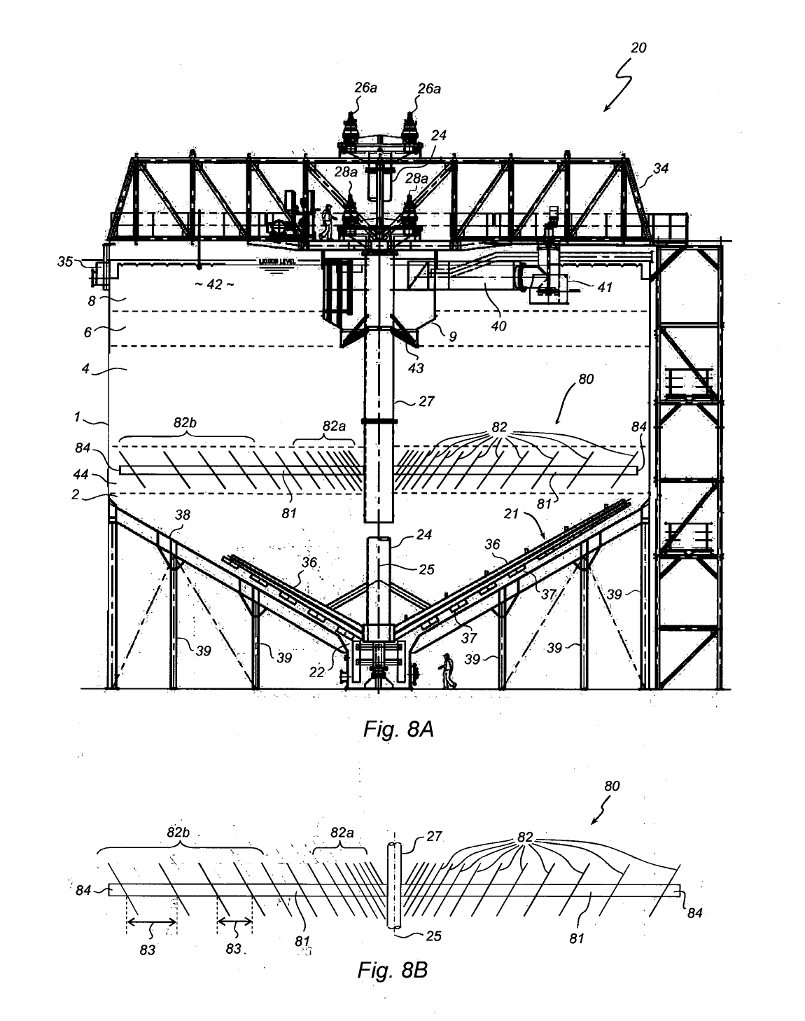

It will be appreciated that the configuration of the shearing device may be varied according to operational and constructional requirements to provide optimal shear, substantially uniform cumulative shear, substantially uniform average shear in the intervals between shearing elements or a substantially uniform number of shear events. Additional non-limiting examples of shearing devices for use in the separation device 20 of the first embodiment of the invention are briefly discussed below in relation to FIGS. 8A to 14, where corresponding features have been given the same reference numerals. In each of these embodiments, the shearing devices operate substantially the same way as described in relation to the first embodiment of FIGS. 2A to 7. That is, FIGS. 8A to 14 illustrate further examples of shearing devices that may be mounted to the concentric drive shaft 27 to enable rotation at a different speed and/or direction to the rake assembly 21, and thus inhibit, reduce or prevent the formation of donuts in the pulp bed 2. In addition, these shearing devices are able to provide a substantially uniform cumulative shear, a substantially uniform average shear between the shearing elements, a substantially uniform number of shear events or any combination thereof to improve the settling process.

Referring to FIGS. 8A and 8B, the separation device 20 has a shearing device 80 mounted to the concentric drive shaft 27 comprising two outwardly extending radial arms 81, with a plurality of shearing elements in the form of angled linear rods or pickets 82 mounted to each radial arm. The pickets 82 are inclined at an angle of approximately 45° with respect to a vertical plane and are spaced at uneven intervals 83 to each other, with the pickets progressively decreasing in number from the central axis 25 to respective outer edges 84 of the radial arms 81. This progressive increase in the intervals 83 is in proportion to the distance of their associated pickets 82 from the central axis 25. As a result, the inner pickets 82a are densely located relative to each other towards the central axis 25, compared to the outer pickets 82b near the outer edges 84.

The shearing device 80 is able to both apply a substantially uniform cumulative shear to pulp exiting the upper region 44 and a substantially uniform average shear in the intervals 83 between the pickets 82 along a radial line defined by the radial arms 81. In respect of the former, the inventors have discovered that angling the pickets 82 to the vertical plane will result in a substantially uniform cumulative shear being applied to pulp exiting the upper region 44. This concept of substantially uniform cumulative shear is explained in more detail below.

If a pulp aggregate or particle is settling at a distance l from the centre at a rate ν m s⁻¹, and the depth of the shear region is d m, then the time taken by the particle to move through the shear region is represented by

θ=d/ν seconds (1)

Assuming that there are, for example, four rotating outwardly extending radial arms (carrying shearing elements in the form of angled pickets) mounted on a centre shaft travelling at a rotational speed of a revolutions per second, the number of “passes” in time θ is represented by:

n=4.θω (2)

This number of passes can also be regarded as the number of shear “events” experienced by each pulp aggregate or particle as the shearing pickets move past. In this context, the shear applied by any individual picket not only includes a direct “hit” of the pulp aggregate by the picket but the disturbance or “shaking” of the pulp aggregate caught in the wake of the passage of the picket, which the inventors call a “zone of turbulence”. These zones of turbulence are sufficient to apply a shear force to the aggregate or pulp particle, albeit less than the amount of shear directly applied by the pickets.

Thus, in the shearing picket configuration of FIGS. 8A and 8B, the probability of a to pulp aggregate or particle being subjected to varying shear rates during the n shearing events is greater for the configuration of FIGS. 8A and 8B than a configuration where the pickets extend substantially vertically, assuming that the number of shear events is significantly greater than 1. That is, as the shearing device 80 makes several passes through the upper region 44 and the pickets 82 are angled, the pulp aggregates or particles are subjected to several varying shear events, either by way of a direct “hit” or being caught in a zone of turbulence. Hence, the total shear applied to a layer of settling pulp aggregates or particles becomes more uniform as n increases and the angle of the pickets φ is increased. However, the inventors believe that increasing φ several degrees beyond 45° is not beneficial because of fluid flow considerations, and substantially uniform cumulative shear is optimally obtained by inclining the shearing elements at 45° to the vertical. Thus, the cumulative shear applied to pulp exiting the upper region 44 is substantially uniform or the same.

As discussed above, the shearing device 80 is also able to apply a substantially uniform average shear between the pickets 82 along a radial line defined by the radial arms 81. This is due to the uneven spacing of the pickets 82 along the radial arms 81. In particular, the inventors have determined that the shear applied to pulp aggregates or particles is generally a function of the linear speed or velocity of the pickets (or other shearing elements) and the distance between the picket and the pulp aggregate or particle. Since the linear velocity of the picket is also a function of the rotational speed of the drive shaft and the distance of the picket from the axis of rotation, the inventors have determined that as the distance from the axis of rotation increases, the linear velocity of the picket increases proportionately. Thus, the shear rate applied to a pulp particle or aggregate by a moving picket is generally expressed by:

γ=k.uₗ/ξ (3)

where γ is the shear rate in s⁻¹,
uₗ is the linear velocity of the picket in ms⁻¹,
ξ is the distance between the picket and the pulp aggregate or particle in metres, and
k is a constant, which is a function of material properties of the pulp.

Also,

uₗ=2πω.l (4)

where ω is the rotational speed of the shaft in s⁻¹; and
l is the distance from the centre in metres.

Thus, for a set of particles (or aggregates) between any two pickets 82, in order to ensure that the average shear is substantially the same or uniform along the line parallel or coincident with the radial arms (i.e. along the length of the radial arm 81), the spacing between the pickets and the aggregates needs to increase proportionally to the linear velocity. That is, the distance or gap between the pickets 82 is in proportion to their distance from the central axis 25 along the radial arm 81. Hence, the requirement for a substantially constant or uniform average shear can be met by increasing the distance or gap between the pickets in proportion to their distance along the radius. By way of contrast, this substantially constant or uniform average shear cannot be achieved by means of a set of evenly spaced pickets or rods fixed to a radial arm, since the linear speed of any such rod is proportional to its distance from the centre.

The outer pickets 82b provide a higher shear force than the inner pickets 82a due to the outer pickets 82b having a greater linear velocity, as indicated by equations (3) and (4). However, due to the denser distribution of the inner pickets 82a compared to the outer pickets 82b, aggregates closer towards the central axis 25 of the shearing device 80 have a more uniform shear profile over a smaller range of shear (in the amount of shear) than that applied to aggregates further from the axis of rotation 25. The shear profiles in the intervals 83 toward the outer edges 84 of the radial arms 81 are relatively less uniform and extend over a larger range or amplitude of shear than the shear profiles in the intervals 83 closer toward the axis of rotation 25. However, due to the differential spacing, the average shear applied to the pulp aggregates in the intervals 83 defined between the pickets 82 will be substantially uniform across the radial arms 27.

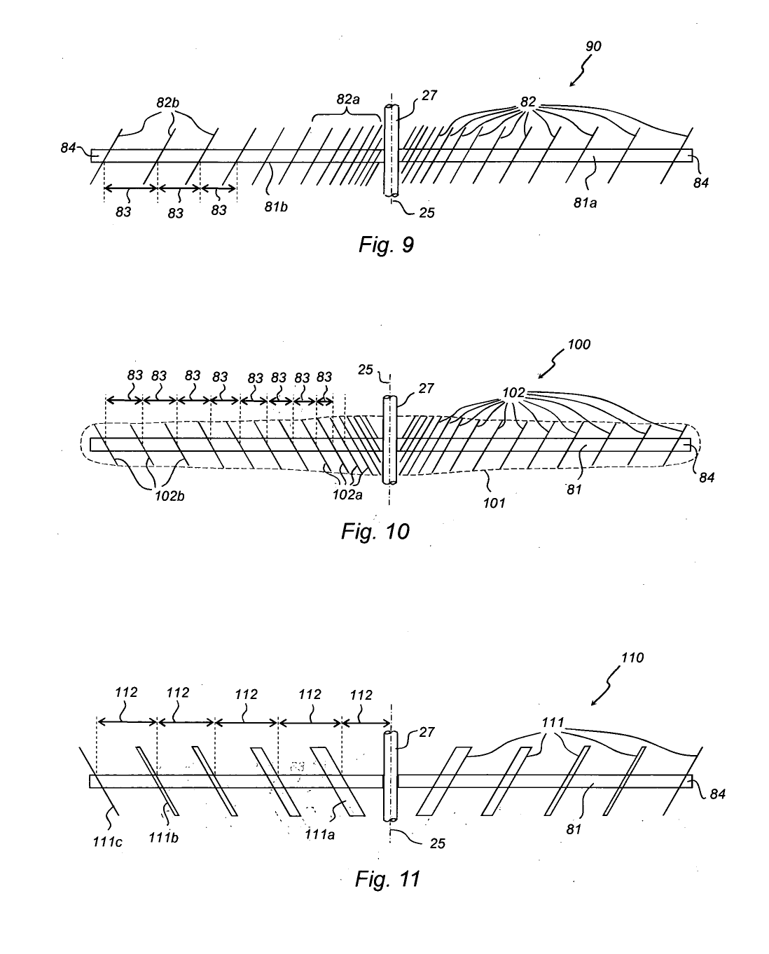

In FIG. 9, the shearing device 90 has angled pickets 82 arranged in an asymmetrical configuration with respect to the central axis 25. The inventors believe that the asymmetric configuration or array further increases the probability of pulp aggregates or particles experiencing multiple varied shear events when passing through the shear region 44 to provide a substantially uniform cumulative shear, in addition to the angling of the pickets 82 at approximately 45° with respect to a vertical plane perpendicular to the radial arm 81 at the respective points of connection. This is because the pickets on one radial arm 81a will apply shear to a different part of the shear region 44 to the pickets 82 on the other radial arm 81b. The pickets 82 are also spaced at uneven intervals 83 that progressively increase in proportion to the distance of their associated pickets from the central axis 25 to the outer edges 84 of the radial arms 81 so that the average shear in the intervals 83 between the pickets 82 is substantially the same. This results in the number of pickets 82 progressively decreasing from the central axis 25 to the outer edge 84 of each radial arm 81.

In FIG. 10, the shearing device 100 has a tapered profile 101 that is defined by angled pickets 102 of differing lengths, together with the radial arms 81. The pickets 102 progressively decrease in length from the central axis 25 to the respective outer edges 84 of the radial arms 81. By progressively reducing the length of the pickets 102 at the outer edges 84, the shearing device 100 reduces the amount of shear applied by the outer pickets 102b. In this embodiment, the shearing device 100 provides a substantially uniform cumulative shear but does not provide a uniform average shear in the intervals between the pickets 102 along a radial line, because the pickets 102 have been spaced at intervals 83 to compensate for their reduced length. While this results in the average shear varying between the pickets 102, the cumulative shear from this picket configuration is substantially uniform, since the increased shear due to the additional pickets 102b at the outer edges counterbalances the reduction in picket length.

In FIG. 11, the shearing device 110 has pickets 111 that vary in thickness and are spaced at intervals 112. Since the shape of the pickets dictates the amount of shear applied to the pulp aggregate, a picket with an increased width will produce a higher amount of shear than a picket having a smaller width. Therefore, in this embodiment, the pickets 111 progressively decrease in thickness from the central axis 25 to the outer edges 84, with the inner pickets 111a having a greater thickness or width compared to the outer pickets 111b and 111c. Thus, the shearing device 110 provides a substantially uniform cumulative shear to the pulp exiting the region 44. Moreover, uniform average shear can be obtained in the intervals 112 between the pickets 111 by suitably progressively decreasing their thickness from the central axis of rotation 25 to the outer edges 84.

Furthermore, the inventors have unexpectedly discovered that the application of a substantially uniform number of shear events across the disturbance zone 44 will also achieve an optimal shear profile that disrupts the networked pulp, thereby releasing trapped liquid and increasing the density of the pulp below the disturbance zone. The inventors have discovered that so long as the number of shear events received by the pulp passing through the disturbance zone 44 is substantially uniform over a predetermined period of time (for example, the period it takes for an x number of revolutions), then shear is being applied substantially uniformly across the disturbance zone, as indicated by equation (2). Thus, the necessary disruption to the networked pulp is obtained, along with the associated release of trapped liquid and increase in the density of the pulp below the disturbance zone 44. It follows that a uniform number of shear events does not require substantially uniform cumulative shear or substantially uniform average shear to be applied at the same time, since the number of shear events is significant and not the amount of each shear event.

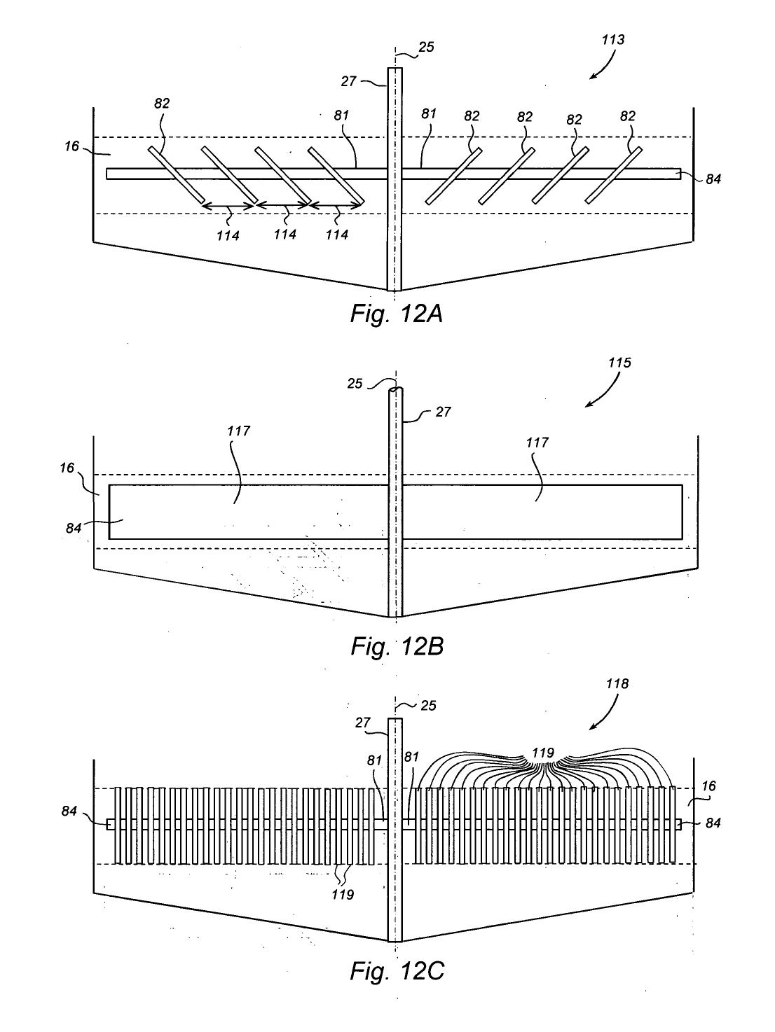

Accordingly, FIGS. 12A, 12B and 12C illustrate shearing devices that achieve a uniform number of shear events without applying substantially uniform cumulative shear or substantially uniform average shear.

In FIG. 12A, where corresponding features have been given the same reference numerals, the shearing device 113 has two outwardly extending radial arms 81, with a plurality of shearing elements in the form of angled linear rods or pickets 82 mounted to each radial arm. The pickets 82 are inclined at an angle of approximately 45° with respect to a vertical plane and are spaced at even intervals 114 to each other from an axis of rotation 25 to respective outer edges 84 of the radial arms 81. The shearing device 113 makes several passes through the disturbance zone 16 and the pickets 82 are angled so that the networked pulp aggregates 13 or particles 12 receive the same number of shear events between entry and exit of the pulp into and out of the disturbance zone 16. However, the even spacing of the pickets 82 means that the average shear in the intervals 114 between each pair of pickets 82 is not the same or uniform along a radial line defined by the radial arms 81. In addition, as the pickets 82 are not arranged to compensate for the progressive increase in linear velocity of the pickets 82 towards the outer edges 84 of the radial arms 81, and thus the amount of shear, then the cumulative amount of shear is not the same of uniform.

Similarly, in FIG. 12B, where corresponding features have been given the same reference numerals, the shearing device 115 has two outwardly extending radial shearing arms 117 that apply shear across their respective lengths, and thus substantially uniformly across the disturbance zone 16. As there are no shearing elements other than the radial arms 117 that occupy the depth of the disturbance zone 16, there are no intervals for average shear nor any way to compensate for the progressive increase in linear velocity of the shearing arms 117 towards their respective outer edges 84.

In FIG. 12C, where corresponding features have been given the same reference numerals, the shearing device 118 has two outwardly extending radial arms 81, with a plurality of shearing elements in the form of substantially vertical linear rods or pickets 119 mounted to and equispaced along each radial arm. In this embodiment, the pickets 119 are grouped closely together in a tight concentration to increase the area of the disturbance zone 16 to approximately 50% of the cross-sectional area of the upper region 17, and hence 50% of the networked pulp in the upper region, that receives a shear event during a pass of the shearing device 118. The shearing device 118 makes several passes through the disturbance zone 16 and the concentration of pickets 119 ensures that 50% of the networked pulp aggregates 13 or particles 12 receive the same number of shear events between entry and exit of the pulp into and out of the disturbance zone 16. As the pickets 119 are equispaced along the radial arms 81, there is no uniform average shear between each pair of pickets 119 along a radial line defined by the radial arms 81. In addition, the pickets 119 are not arranged to compensate for the progressive increase in linear velocity of the pickets 119 towards the outer edges 84 of the radial arms 81, and hence, the amount of shear. Consequently, the cumulative amount of shear is not the same or uniform. In one variation, another set of radial arms 81 are provided with pickets 119 offset to the pickets 119 on the first set of radial arms 81 to apply shear in the intervals and thus increasing the disturbance zone 16 to encompass the entire upper region 17 (100%), and thus apply shear to the entire (100%) networked pulp passing through the upper region.

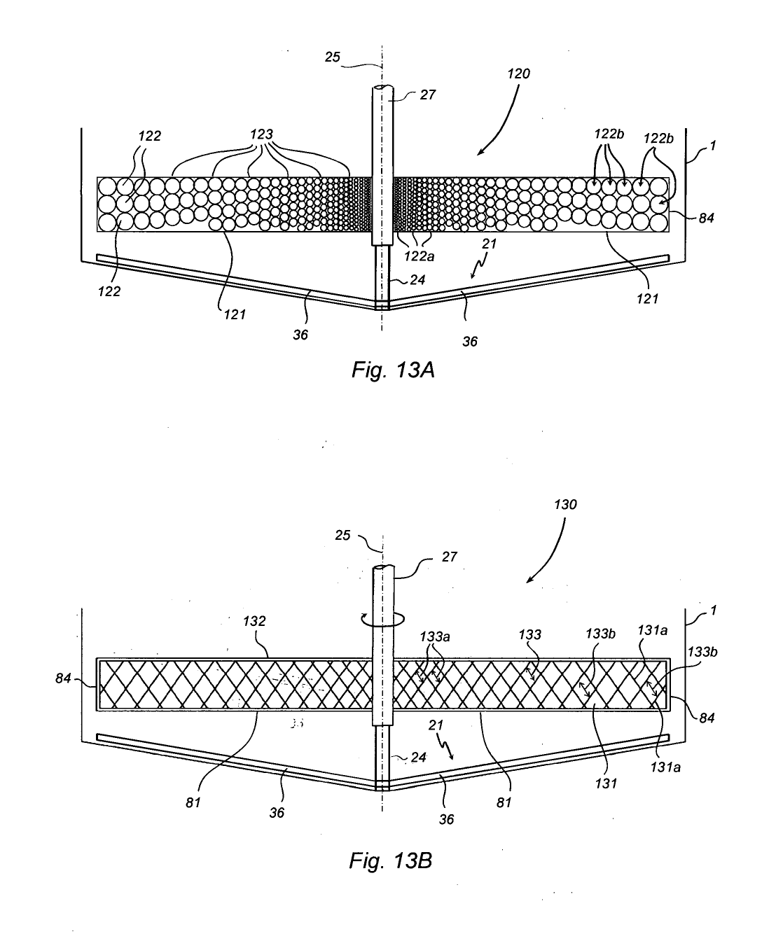

Referring to FIG. 13A, the shearing device 120 in this embodiment of the invention comprises two substantially vertical plates 121 each having a series of holes or apertures 122 that are substantially aligned vertically in “columns” 123. Unlike the previously described shearing devices, the holes 122 apply shear to the pulp passing through the region 44. This is because the movement of the plates 121 causes the pulp aggregates or particles to be forced or “squeezed” through the holes 122, thus resulting in the pulp aggregates or particles experiencing a shear force applied by the edges of the holes 46 and a more concentrated distribution of shear within the smaller holes 46a. In addition, the holes or apertures 122 progressively increase in diameter from the central axis 25 to the respective outer edges 84 of the plates 121 to provide the substantially same effect as the less dense distribution of the outer pickets 82b in the shearing device of FIG. 8. In this case, the smaller holes 46a toward the rotational axis 29 travel at a lower velocity compared to the larger holes 46b toward the outer edges 31, but have a more concentrated distribution of shear than the larger holes 46b due to their smaller diameter.

Thus, as the shearing device 120 rotates, the pulp particles or aggregates closer to the axis of rotation 25 experience a more uniform series of shear events that vary over a smaller range (in the amount of shear) than the pulp aggregates or particles at the outer edges 84 of the shearing plates 121 due to the higher number, decreased size and lower linear velocity of the inner holes 122a. The increased areas of the outer holes 122b are designed to offset their increased linear velocity at the outer edges 84 compared with the lower linear velocity of the smaller inner holes 122a. Hence the outer holes 122b provide a less uniform shear profile over a larger range or amplitude of shear than the shear profile applied by the inner holes 122a to the aggregates closer towards the axis of rotation 25. In other words, the size of the holes 122 progressively increases from the rotational axis 25 to the outer edges 84. Thus, the shearing device 120 provides a substantially uniform cumulative shear to the pulp exiting the region 44.

It will be appreciated that the holes 46 need not be organised in regular columns 123, but can be arranged in other configurations. For example, the holes 122 could be aligned at an angle to the vertical to define angled columns or even randomly arranged provided that the hole diameter progressively increases towards the outer edges 84. In one particular variation, the diameter size of the holes 122 can be suitably adjusted to obtain uniform average shear in the intervals as defined by the respective diameters of the holes, namely by ensuring that the progressively larger holes are located in proportion to their distance from the axis of rotation 25. In another variation, the diameter size of the holes 122 are substantially the same or uniform, thus resulting in a substantially uniform number of shear events being applied to the networked pulp in the disturbance zone.

Referring to FIG. 13B, the shearing device 130 in this embodiment of the invention is formed with a mesh 131 having a diamond pattern, structurally supported by a border 132 defining the outer perimeter of the mesh. The spacing or interval 133 between each mesh element 131a progressively increases in proportion to the distance of their associated mesh elements from the central axis 25 to the outer edges 84 such that the inner intervals 133a are less than the outer intervals 133b, thus achieving a similar effect as the uneven intervals 83 between the pickets 82 in the shearing device of FIG. 8. The inventors have found that both the cumulative shear applied by the shearing device 130 and the average shear in the intervals 133 between each part of the mesh 131 are each separately substantially uniform or the same. It will be appreciated that other patterns can be used for the mesh 131, for example, hexagonal, octagonal and other polygonal shaped patterns or even combinations of polygonal shapes, whether regular or randomised. The inventors have found that both the cumulative shear applied by the shearing device 130 and the average shear in the intervals 133 between each part of the mesh 131 are each separately substantially uniform.

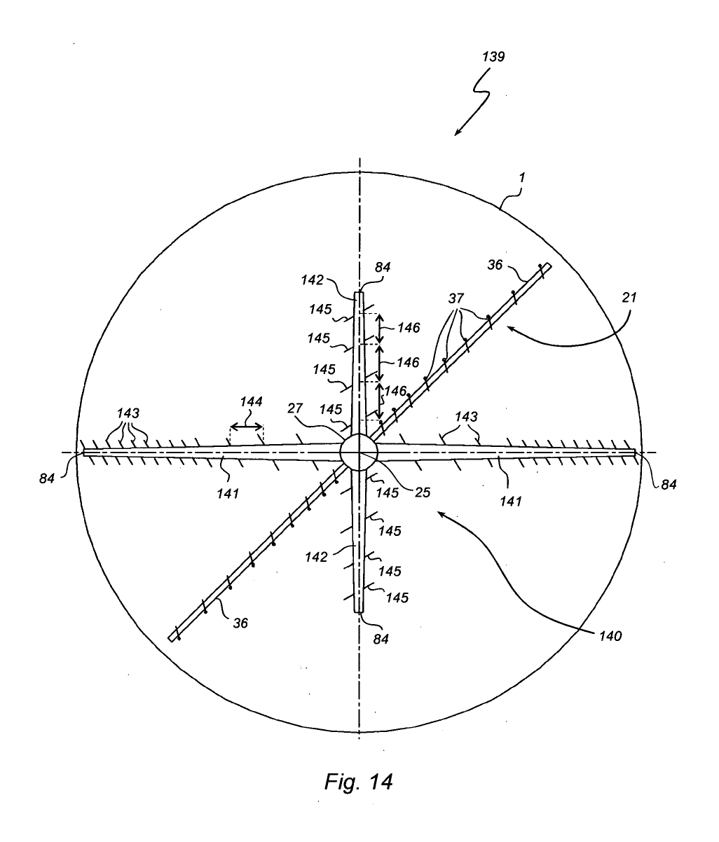

Referring to FIG. 14, the separation device 139 in this embodiment of the invention comprises a shearing device 140 formed with two pairs of radial arms, one pair of radial arms 141 being longer than the other pair of radial arms 142. The picket configuration on the radial arms 141 has a tapered profile due to the progressively decreasing length of the angled pickets 143 and is arranged asymmetrically about the central axis 25. However, unlike any of the previous embodiments, the number of pickets 143 progressively increases from the central axis of rotation 25 to the respective outer edges 84 as the uneven intervals 144 progressively decrease. The other pair of radial arms 142 have pickets 145 arranged asymmetrically about the central axis 25, although at even intervals 146 rather than uneven intervals so that the pickets 145 apply shear in the intervals 144 between the pickets 143 of the longer radial arms 141.

As a result, neither the longer radial arms 141 nor the shorter radial arms 142 individually provide a uniform cumulative shear. However, the second pair of radial arms 142 is arranged to compensate for the first pair of radial arms 141 so that the shearing device 140 achieves a substantially uniform cumulative shear effect. The inventors also believe that this effect is further enhanced by using different configurations for the plurality of pickets on the respective pairs of radial arms 141 and 142.

There is no uniform average shear in the intervals 144 and 146 between the pickets 143 (due to the reduced picket length) or the pickets 145 (due to the evenly spaced intervals 146). However, the overall average shear from a sum of the average shears from the intervals of the pickets 143 of the longer radial arms 141 and the pickets 145 of the shorter radial arms 142 is substantially uniform or the same, because the variances in the average shear in the intervals 146 between the pickets 145 are counterbalanced by the variances in the average shear in the intervals 144 between the pickets 143.

In this embodiment, it is also contemplated that either the longer radial arms 141 or the shorter radial arms 142 could be configured to be removed or added into the shear region 43. In such a case, the additional radial arms can be arranged so that the overall cumulative shear is maintained substantially uniform or the overall average shear is maintained substantially uniform.

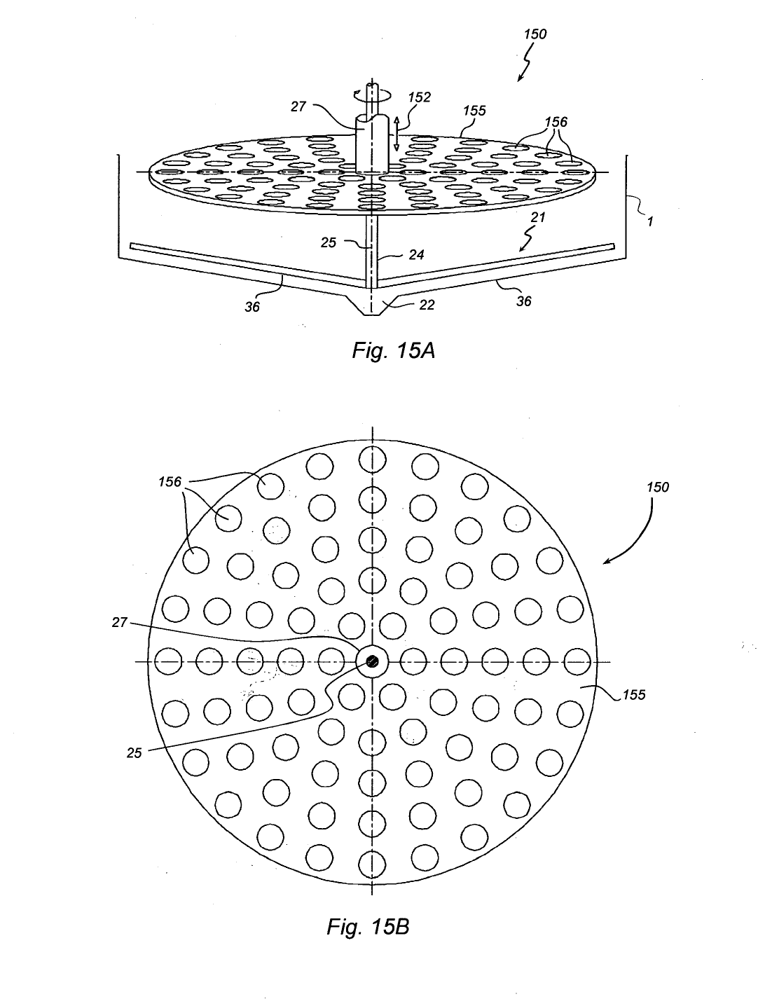

Referring to FIGS. 15A and 15B, a further embodiment of the invention is illustrated, where corresponding features have been given the same reference numerals. The separation device 150 comprises a shearing device 151 mounted to the concentric drive shaft 27 for substantially vertical motion 152 parallel to the central axis 25 of the tank 1 and the rake assembly drive shaft 24. The shearing device 151 comprises a substantially circular plate 155 arranged substantially horizontally with respect to the tank 1 and having a series of holes or apertures 156 that are equally spaced from each other. The concentric drive shaft 151 reciprocates the plate 155 substantially vertically with respect to the pulp bed 2 and the tank 1, as indicated by arrow 152. The inventors believe that this reciprocating vertical motion 152 results in a similar complex fluid motion and turbulence in the shear region 44 that inhibits or prevents the formation of donuts around the concentric drive shafts 27 and the rake assembly 21. This vertical motion 152 also causes a substantially uniform shear, and thus a substantially uniform cumulative shear, being applied to pulp passing through the region 44 in a similar manner to that described in relation to the previous shearing devices, although using a vertical component of movement for the shearing device 150 rather than rotation around an central axis 25 coincident with the central drive shaft 154. As the holes 156 are substantially equal in size the applied shear is substantially uniform, thus resulting in a substantially uniform cumulative shear and a substantially uniform number of shear events. Preferably, the amount of vertical movement is about 500 mm upwardly and downwardly, or in total around 1 m.

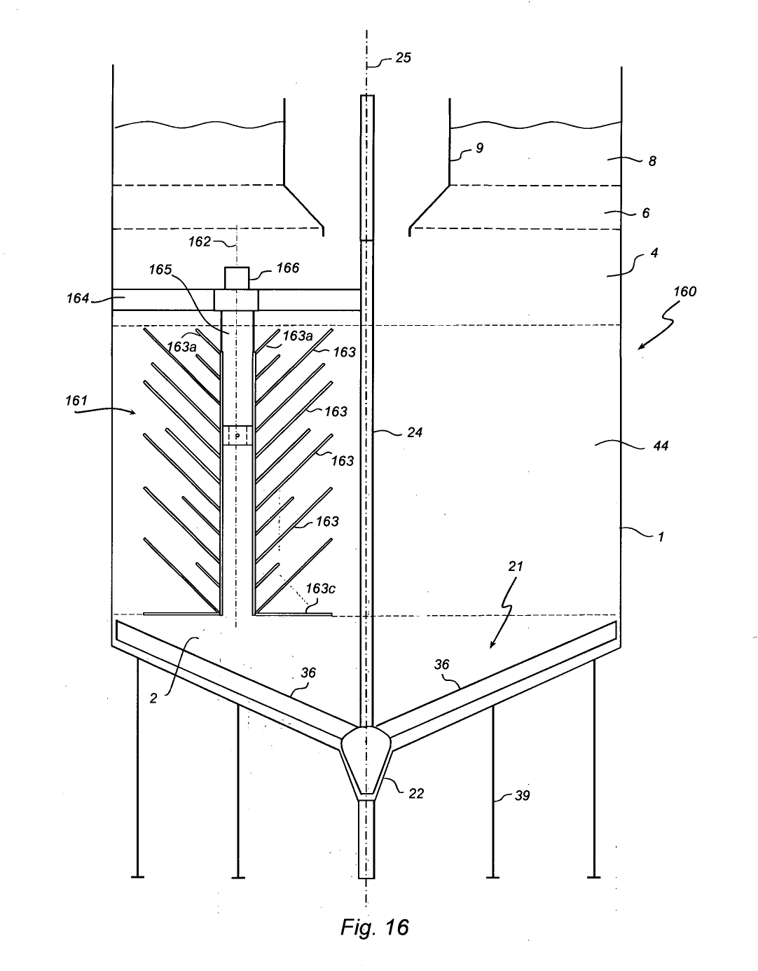

Referring now to FIG. 16, a further embodiment of the invention is illustrated, where corresponding features have been given the same reference numerals. The separation device 160 comprises a shearing device 161 mounted for rotation about an axis 162 that is eccentric or offset with respect to the central axis 25 of the tank 1. The shearing device 161 comprises a tree-like array of angled pickets 163 and is connected to a central drive shaft 24 axially aligned with the central axis 25 of the tank 1 by way of a support 164 and associated drive shaft 165. The central drive shaft 24 rotationally drives the support 164 to rotate the eccentric axis 162 about the central axis 25. Thus, there are two components of rotational movement, the rotation of the shearing device 160 about its eccentric axis of rotation 162 and the rotation of the eccentric axis 162 itself about the central axis 25, akin to planetary motion. That is, the motion of a spinning planet revolving in orbit around a central axis defined by the sun.

The central drive shaft 24 drives rotation of the support 164 via an epicyclic gear assembly (not shown) similar to the gear assembly for the shearing device drive assembly as described in relation to FIG. 5. Alternatively, the one or more pinion drives (not shown) or a peripheral drive (not shown) may rotationally drive the support 164 via gear assembly. This enables multiple input drives to be used that can supply an increased amount of torque to the shearing device 161, with the rotational speed of the drive shaft 165 being a function of the drive speed of the input drives and the ratios of the drive gears in the epicyclic gear assembly.

In this embodiment, an independent drive mechanism 166 drives rotation of the shearing device 161 about the axis of rotation 162, while the central drive shaft 24 drives rotation of the rake assembly 21. Consequently, the shearing device 161 can be rotated at a different speed to the rake assembly 21, or even counter-rotated in the opposite direction, to inhibit, prevent or minimise the formation of donuts in the pulp bed 2.

By splitting the rotation of the shearing device 161 from the rotation of the rake assembly 21, this embodiment also advantageously permits the provision of low torque drives for both the shearing device 161 (due to the small mechanism diameter) and the central drive shaft 24 (due to the reduced area of the central drive mechanism, as it does not have to drive the shearing device 161). However, the embodiment can be equally applied to larger tanks requiring larger torques.

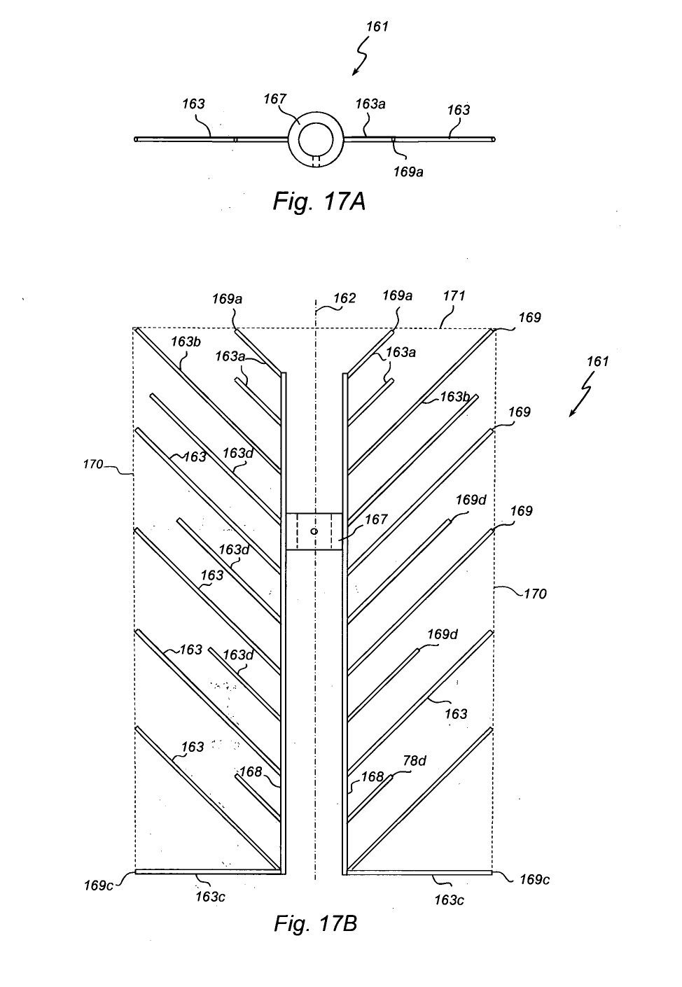

Referring to FIGS. 17A and 17B, the shearing device 161 has a collar attachment 167 for fixing the pickets 163 to the drive shaft 165. The pickets 163 are arranged in a tree-like array or structure, with two parallel stems 168 from which the pickets 163 extend at an angle of inclination of approximately 45° to the vertical plane. The pickets 163 are arranged so that their tips 169 are substantially aligned with a vertical line 170. At the top of the shearing device 167 are four smaller pickets 163a which are arranged so that the top two pickets have their tips 169a substantially aligned in a horizontal plane 171 with the uppermost of the pickets 163b, as best shown in FIG. 17B. A pair of lower horizontal pickets 163c terminate so that their tips 169c are substantially aligned with the vertical lines 170. Thus, the pickets 163 define a substantially rectangular shape having a width which substantially approximates to the radial cross-section of the thickener tank 1. A set of progressively shorter pickets 163d alternate between the longer pickets 163 with their respective tips 169d pointing upwardly. These shorter pickets 163d provide an increased number of shear events closer towards the eccentric axis 162, where the linear velocity of the pickets is reduced, as discussed above.

In operation, the central drive shaft 24 rotates the support 164 around the thickening tank 1 about the central axis 25 clockwise or counter-clockwise, thus rotating the eccentric axis 162 about the central axis 25. Simultaneously, the drive mechanism 166 drives the shearing device 161 separately so as to rotate the pickets 163 around the eccentric axis 162 clockwise or counter-clockwise to shear the pulp aggregates or particles. A particular advantage of this embodiment is that the dual rotation of the shearing device 161 provides a more complex fluid motion than previous embodiments, thus increasing the difficulty for any significant volume of pulp solids in the thickened pulp bed 2 to form a stable agglomerated mass that would rotate with the shearing device 161 and/or rake assembly 21 and thus cause donutting. That is, the rotation of the pickets 163 about the eccentric axis 162 and relative rotation of the shearing device 161 about the central axis 25 causes a relatively complex sweeping motion in the pulp bed 2 that hinders or prevents the formation of pulp agglomerates around the central drive shaft 24, thus minimising or eliminating donutting. Consequently, a relatively uniform layer of thickened pulp with an improved underflow density is achieved in the pulp bed 2.

In other embodiments, the eccentric axis 162 need not traverse a regular circular orbit around the central axis 24. The eccentric axis 162 may only traverse an arcuate path, or partial orbit, and not a full orbit around the central axis 24. For example, the eccentric axis may oscillate between two points. Other possible motions include elliptical, precession-like or partial orbits around the central axis 24, and may even have an irregular orbit. For example, the orbital radius of the eccentric axis 162 may vary as it rotates about the central axis 24 of the tank 1, producing a meandering orbit whereby the radial distance between the central axis and the eccentric axis progressively changes. Such variations in the movement of the eccentric axis 162 further increase the complexity of the motion in the pulp bed 2 and thus reduce the possibility of donutting.

A further advantage of this embodiment is that the shearing devices become “self-flushing” of solids. That is, the rotation of the shearing device enables solids to be more easily removed, thus further assisting the prevention of donutting. In addition, the configuration of the pickets 163 results in the shearing device 161 applying a substantially uniform cumulative shear to the pulp passing through shear region 44 of the pulp bed 2.

It will also be appreciated by those skilled in the art that the drives and support mechanisms can be located anywhere in or on the separation device, as desired. For example, the support can be disposed adjacent the top or bottom of the tank, or anywhere in between. Similarly, the drive or drives can be located adjacent the top or bottom of the tank, within the tank perimeter, at its outer perimeter adjacent the tank sidewall or any combinations of these locations.

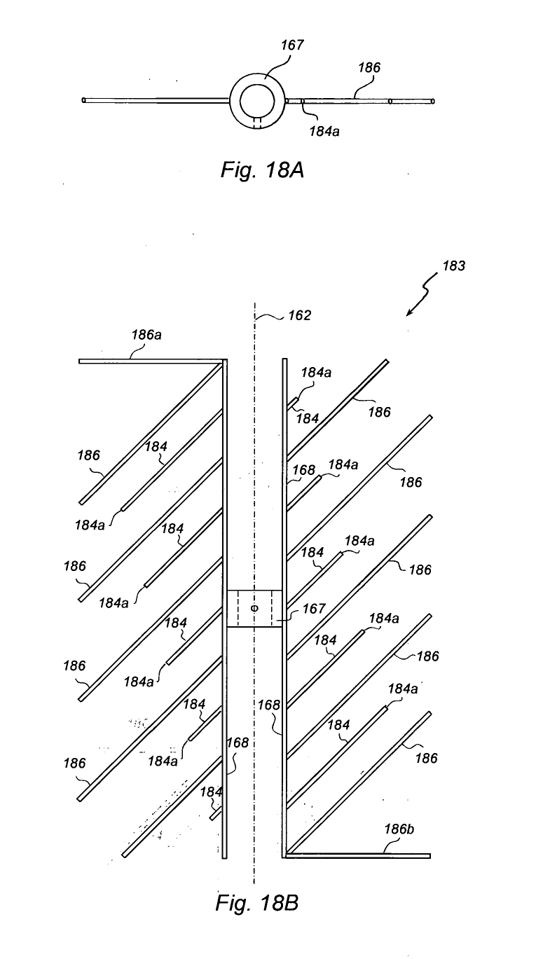

Additional shearing device configurations for the separation device 160 are illustrated and briefly described in relation to FIGS. 18A to 22B, where corresponding features have been given the same reference numerals. As these shearing devices substantially operate in the same manner as the operation of the shearing device 161, a detailed description of their operation will not be repeated.

Referring to FIGS. 18A and 18B, the shearing device 183 is arranged so that progressively shorter angled pickets 184 on either side of the stems 168 have their respective tips 184a pointing outwardly and alternate between relatively longer angled pickets 186. Again, the shorter pickets 184 provide an increased number of varied shear events closer towards the rotational axis 162. Both sets of “primary” pickets 186 and “secondary” pickets 184 are asymmetrical with respect to the axis of rotation 162. Two of the pickets 186a and 186b extend substantially horizontally at the top and bottom portions of the shearing device 183, respectively. The primary pickets 186 also define a substantially rectangular cross-section approximating the radial cross-section of the tank.

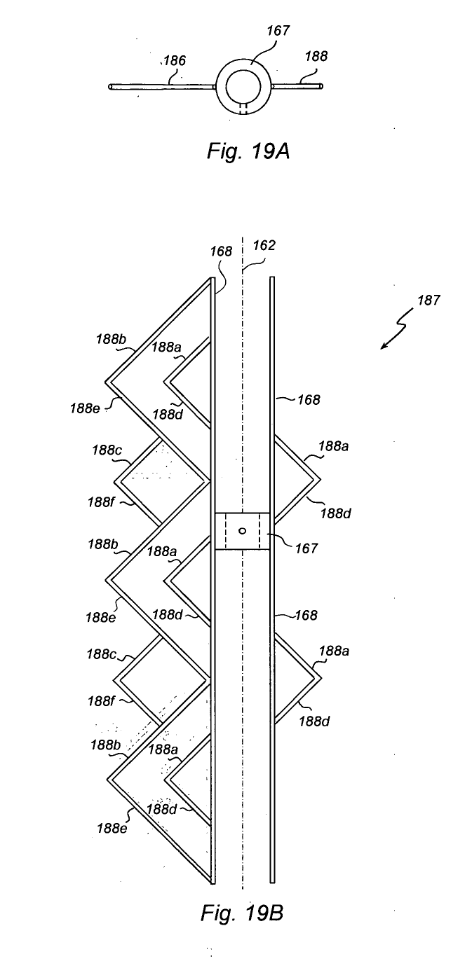

Referring to FIGS. 19A and 19B, the shearing device 187 comprises a plurality of angled pickets 188 arranged in a zigzag-like fashion to define a tiered saw-tooth like profile. Pickets 188a, 188b and 188c extend downwardly relative to the stems 168, whereas the pickets 188d, 188e and 188f extend upwardly relative to the stems. The downwardly extending pickets 188a, 188b and 188c are connected to the upwardly extending pickets 188d, 188e and 188f, respectively, to define an asymmetric picket configuration. One side of the shearing device 187 has two “tiers” of teeth, comprising an inner tier of pickets 188a and 188d and an outer tier of pickets 188b and 188e, with the pickets 188c and 188f supplementing the outer tier. The other side of the shearing device has a single inner tier of pickets 188a and 188d. This picket configuration provides an increased number of varied shear events closer towards the rotational axis 162.

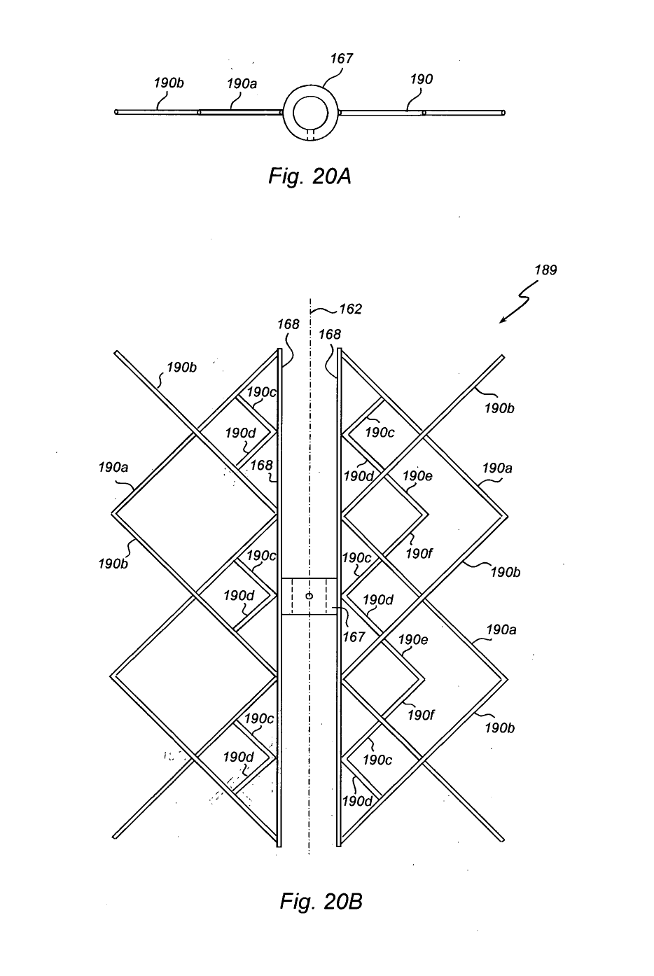

Referring to FIGS. 20A and 20B, the shearing device 189 has a plurality of pickets 190 that form an asymmetric mesh-like structure, similar to the mesh 49 illustrated in the embodiment of the invention of FIG. 13. Pickets 190a, 190d and 190e extend downwardly with respect to the. stems 168, whereas the pickets 190b, 190c and 190f extend upwardly with respect to the stems. The pickets 190 are arranged so that a downwardly extending picket 190a crosses an upwardly extending picket 190b to define an “X”-shape, with each “X” being joined together to define a general diamond-like mesh appearance. Secondary upwardly extending pickets 190c and downwardly extending pickets 190d are disposed adjacent the stems 168, with the upwardly extending pickets 190c connected to the upwardly extending pickets 190d. An additional set of pickets 190e and 190f are disposed between two X-shapes to provide an asymmetric configuration. The pickets 190 are angled at approximately 45° to the vertical plane. Again, this picket configuration provides an increased number of varied shear events closer towards the rotational axis 162.

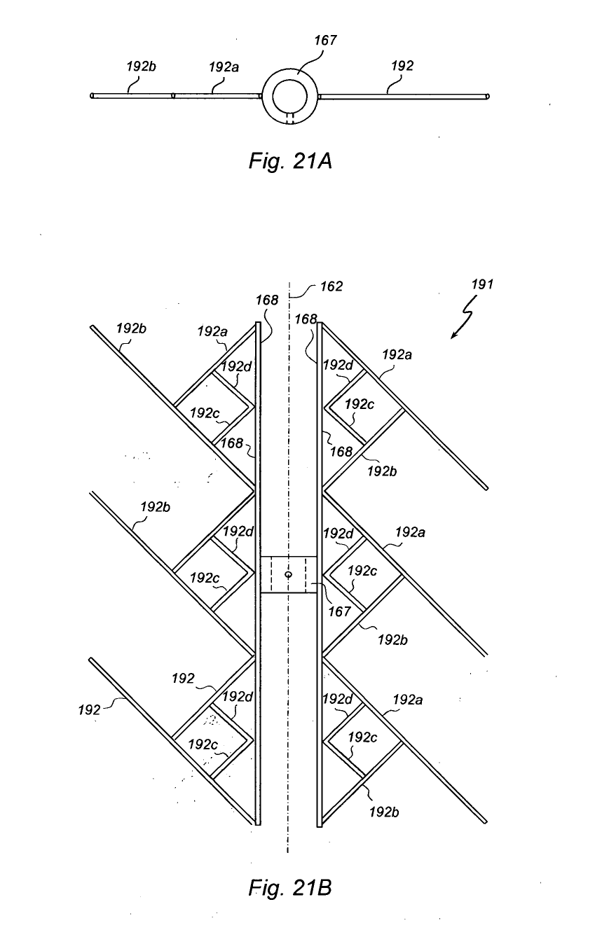

Referring to FIGS. 21A and 21B, the shearing device 191 has a plurality of pickets 192 that are arranged asymmetrically about the axis of rotation 162. The pickets 192a extend downwardly while pickets 192b extend upwardly relative to their respective stems 168, the downwardly extending pickets 192a being connected to upwardly extending pickets 192b. Each of the pickets 192 is angled with respect to the vertical plane at approximately 45°. There is an inner set of secondary pickets adjacent the stems 168, with downwardly extending pickets 192c connected to upwardly extending pickets 192d. This picket configuration provides an increased number of varied shear events closer towards the rotational axis 162.

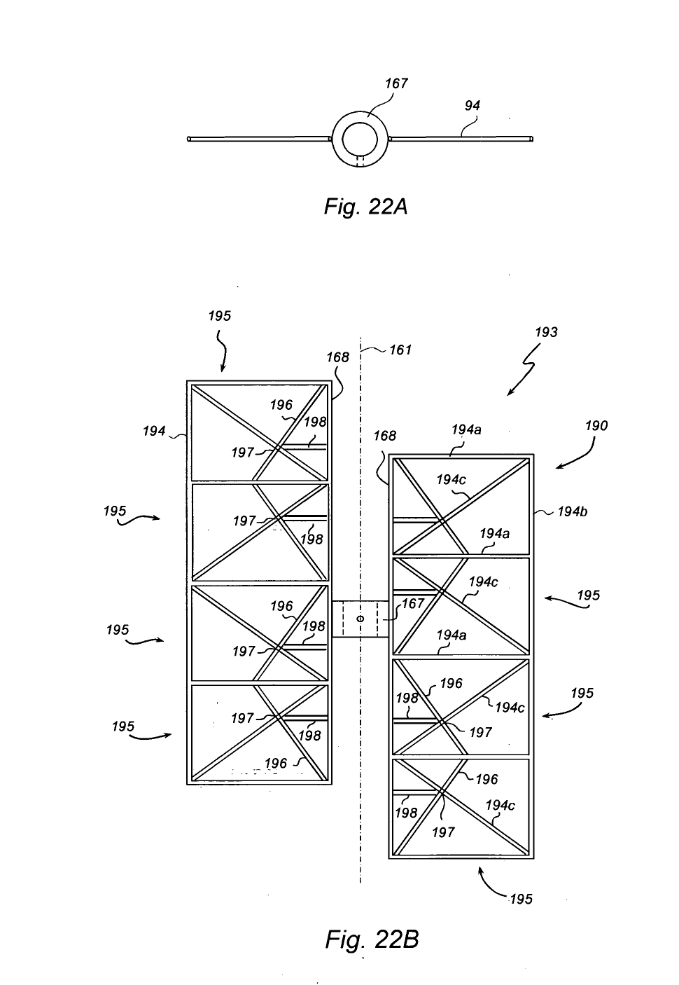

Referring to FIGS. 22A and 22B, the shearing device 193 has a plurality of pickets 194 arranged to define vertically offset box-like structures 195, with horizontal pickets 194a and vertical pickets 194b defining the horizontal and vertical sides of the boxes 195, respectively. In addition, diagonally extending pickets 194c connect one pair of corners of each box 195 in a zigzag-like fashion to define a saw-tooth-like path, the pickets 194c being angled at approximately 45° to the vertical plane. Angled pickets 196 intersect the pickets 194c so that the point of intersection 197 is offset to the centre of each box 195 and are disposed in a similar zigzag-like fashion to define a saw-tooth-like path. Furthermore, horizontal pickets 198 are provided that connect the respective points of intersection 197 to the stems 168. This picket configuration provides an increased number of varied shear events closer towards the rotational axis 162.

In other embodiments, the shearing devices illustrated in FIGS. 2A, 2B and 8A to 15B are mounted for rotation about a parallel, eccentric or offset axis to the central axis 25 of the tank 1 in the manner illustrated in FIG. 16. Likewise, the configurations of the shearing devices illustrated in FIGS. 16 to 22B may also be suitably modified for rotation about the central axis 25 using a concentric drive shaft in the manner illustrated in FIGS. 2 to 14. Furthermore, the shearing devices of FIGS. 2, 8 to 14 and 16 to 22B may also be suitably adapted for substantially vertically reciprocating motion parallel to, rather than rotation about, the central axis 25. While the embodiments have been described with reference to the rake assembly 21 being rotated about a central axis of the tank, it will be appreciated that the rotational axis of the rake assembly may also be parallel, offset or eccentric to the central axis of the tank.

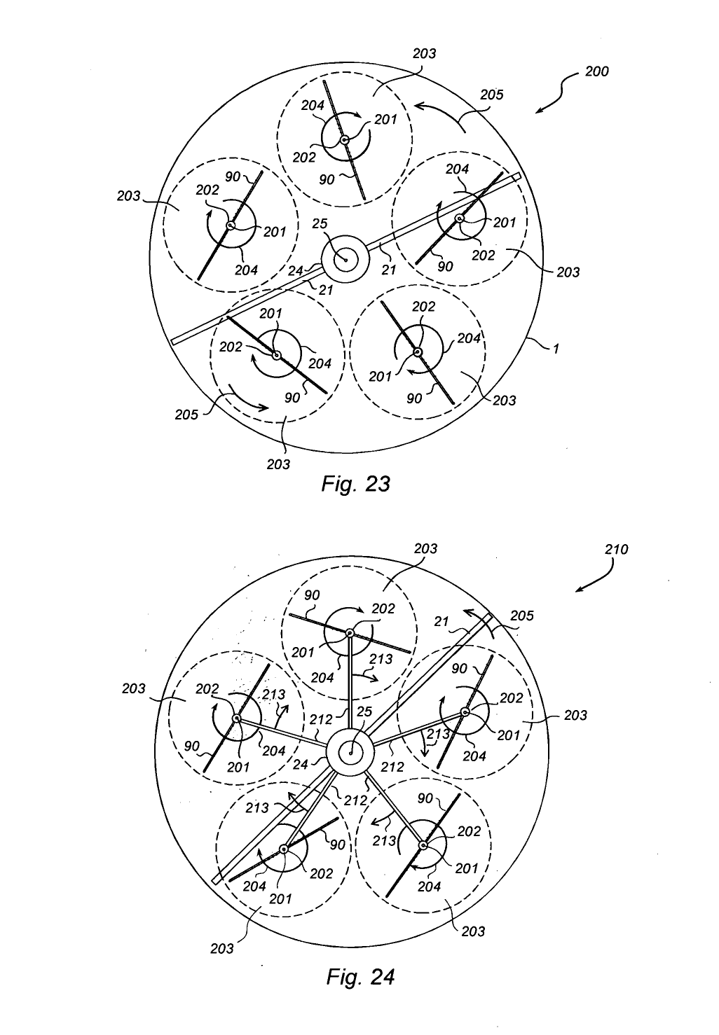

It will also be appreciated that multiple shearing devices can be provided in the separation device, to further enhance minimisation or prevention of donuts forming in the pulp bed 2, as the presence of multiple shearing devices will create more complex fluid motion within the tank 1. FIG. 23 illustrates a further embodiment of the invention, where corresponding features have been given the same reference numerals. In this embodiment, a thickener 200 has multiple shearing devices 90 arranged circumferentially around the tank 1. The shearing devices 90 have an asymmetric picket configuration, as described in relation to the embodiment of FIG. 9, and rotate about axes of rotation 201 via associated drive shafts 202 and independent drive mechanisms (not shown). The rotational axes 202 are offset or eccentric with respect to the central axis 25 of the tank 1, as well as being fixed relative to the central axis so that the shearing devices 90 are stationary in the tank. Thus, each shearing device 90 applies shear to a designated region 203 of the tank 1 by rotation in their respective clockwise directions 204. Although their rotational axes 201 are fixed, the shearing devices 90 produce a complex fluid motion within the tank to inhibit, prevent or minimise donut formation in the pulp bed 2. This complex fluid motion is enhanced when the shearing devices 90 are counter-rotated with respect to the rake assembly 21, as shown in FIG. 23. That is, the shearing devices 90 each rotate clockwise, whereas the rake assembly 21, which is mounted for rotation about the central axis 25 via a central drive shaft 24, rotates in a counter-clockwise direction, as indicated by arrow 205. It will be understood that the shearing devices 90 are rotatable at different speeds and/or in different (or opposite) directions with respect to each other and/or the rake assembly 21, to add further complexity to the fluid motion within the tank 1.

FIG. 24 illustrates a further embodiment of the invention, where corresponding features have been given the same reference numerals. In the thickener 210, multiple shearing devices 90 are mounted for rotation about the central axis 25 of the tank 1 in a similar manner to the further embodiment of FIG. 16. That is, the rotational axes 201 of the shearing devices 90 are not fixed, but are now rotatable about the central axis 25, by rotatably mounting the drive shafts 202 of the shearing devices 90 to radially extending supports 212. As in FIG. 23, the rotational axes 201 remain eccentric or offset with respect to the central axis 25. The supports 212 are mounted to the central drive shaft 24 for rotation about the central axis 25. Thus, the shearing devices 90 rotate about their respective rotational axes 201 in a clockwise direction, as indicated by arrows 204, and their respective rotational axes 201 rotate about the central axis 25 via the supports 212 in a clockwise direction, as indicated by arrow 213. This dual rotation of the shearing devices 90, akin to planetary motion, produces a complex fluid motion within the tank to inhibit, prevent or minimise donut formation in the pulp bed 2. As described above, this complex fluid motion is enhanced when the shearing devices 90 are counter-rotated with respect to the rake assembly 21, as shown in FIG. 24, where the shearing devices 90 and their rotational axes 201 each rotate clockwise, whereas the rake assembly 21 rotates in a counter-clockwise direction, as indicated by arrow 205. As previously discussed, the shearing devices 90 are rotatable at different speeds and/or in different (or opposite) directions with respect to each other and/or the rake assembly 21, to add further complexity to the fluid motion within the tank 1.

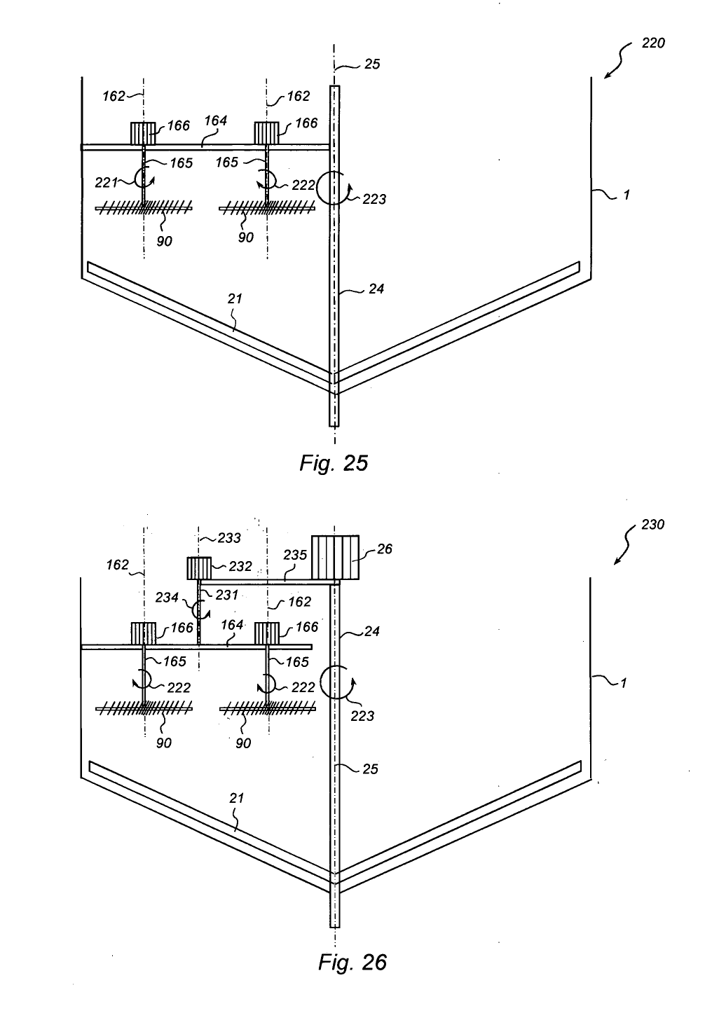

Another embodiment of the invention is illustrated in FIG. 25, where corresponding features have been given the same reference numerals. In this embodiment, the thickener 220 has two shearing devices 90 mounted to a support 164, which is rotatable about the central axis 25 in the tank 1 via the central drive shaft 24. Each of the shearing devices 90 are independently mounted for rotation about respective rotational axes 162 via associated drive shafts 165 and drive mechanisms 166. The shearing devices 90 are arranged to counter-rotate at different rotational speeds and in opposite directions (clockwise and counter-clockwise) with respect to each other, as indicated by arrows 221 and 222, respectively. The rotational axes 162 are both rotatable with respect to the central axis 25, and eccentric or offset with respect to the central axis 25. The support 164 rotates in a counter-clockwise direction, as indicated by arrow 223. Thus, the dual rotation of the shearing devices 90 about their respective rotational axes 162 and the central axis 25 provides a complex fluid motion to inhibit, prevent or minimise the formation of donuts in the pulp bed 2. As previously discussed, the shearing devices 90 are rotatable at different speeds and/or in different directions with respect to each other, the support 164 and/or the rake assembly 21, to add further complexity to the fluid motion within the tank 1.

FIG. 26 illustrates a further embodiment of the invention, where corresponding features have been given the same reference numerals. In this embodiment, the thickener 230 has a similar arrangement to the thickener 220 of FIG. 25, with two shearing devices 90 mounted for rotation about respective rotational axes 162 via a first support 164 to which are mounted their respective drive shafts 165 and associated drive mechanisms 166. The shearing devices 90 also both rotate in a clockwise direction, as indicated by arrows 222. However, it will be appreciated that the shearing devices 90 can rotate in different or opposite directions with respect to each other.

The first support 164 is rotated by a separate drive shaft 231 and associated drive mechanism 232 in a counter-clockwise direction about an axis 233, as shown by arrow 234. The separate drive shaft 231 and associated drive mechanism 232 are mounted on a second support 235 that is rotatable about the central axis 25 in a counter-clockwise direction (as shown by arrow 223) via the central drive shaft 24 and associated drive mechanism 26. Thus, there are three separate components of rotation; the clockwise rotation of the shearing devices 90 about the rotational axes 162, the counter-clockwise rotation of the first support 164 about the rotational axis 233 and the counter-clockwise rotation of the second support 235 about the central axis 25. This configuration also provides a more complex fluid motion to inhibit, prevent or minimise the formation of donuts in the pulp bed 2. As previously discussed, the shearing devices 90 are rotatable at different speeds and/or in different (or opposite) directions with respect to each other, the first support 164, the second support 235 and/or the rake assembly 21, to add greater complexity to the fluid motion within the tank 1.

It can therefore be seen that adding multiple shearing devices in the manner described above introduces further complex fluid motion in the tank that enhances the prevention, inhibition or minimisation of donuts forming in the pulp bed. Moreover, it is contemplated that in addition to varying their rotational speeds, multiple shearing devices can be used having different picket configurations, different three dimensional geometrical shapes, different depth placements (to apply shear in different regions), different spatial locations (for example, to permit intermeshing of the shearing devices so that their shearing regions overlap), or any combination of these different configurations to create a more complex fluid motion that prevents, inhibits or minimises donut formation in the pulp bed.

In addition, the preferred embodiments in FIGS. 8A to 13 and 16 to 22B have been described and illustrated with pickets angled with respect to a vertical plane that is at right angles to the radial arm. However, it will be appreciated that the pickets can be angled with respect to other vertical planes, such as a vertical plane parallel to or coplanar with the radial arms, as illustrated in FIGS. 2 and 14. In other embodiments, the pickets may be only angled with respect to the vertical plane parallel to or coplanar with the radial arms.

Moreover, whilst the preferred embodiments of the invention have been described as employing shearing elements in the form of linear pickets or rods, it would be appreciated by one skilled in the art that other configurations for the shearing elements can be used, such as V-shaped angled rods, half or semi-circular tubes or other shearing elements having different polygonal cross-sections. In particular, the pickets themselves can be altered in shape to produce the desired shear profile. For example, a non-linear picket can be used, such as a spiral or helical shape.

While the preferred embodiments have been described and illustrated in a manner to produce an optimal shear substantially uniformly across the disturbance zone 44, especially where the disturbance zone includes substantially the entire upper region, one skilled in the art will appreciate that similar advantageous effects could be obtained by causing the optimal disturbance or applying the optimal shear across a disturbance zone that is a proportion of the upper region. This proportion of the upper region may include a partial cross-sectional area or even a partial volume of the tank. For example, individual pickets can be removed from the radial arms so that the optimal shear occurs at a series of intervals, or mostly only towards the outer perimeter of the tank 1 or towards the inner radial area of the tank adjacent or close to the axis of rotation. In this case, the disturbance zone 44 is effectively segmented across the cross-section of the tank 1. Alternatively, it could be viewed as providing multiple disturbance zones separated by quiescent areas in the upper region. On either interpretation, the optimal disturbance caused or shear applied substantially uniformly across a disturbance zone can occupy at least 10% of the volume of the upper region up to the entire upper region (100%). As the amount of pulp approximates to the cross-sectional area of the upper region 17, then the disturbance or shear is applied to at least 10% to 100% of the networked pulp in the upper region within a predetermined period of time corresponding to the passage of the networked pulp through the disturbance zone 44.

The inventors recognise that there may be situations where it is desired that not all of the networked pulp is subjected to a disturbance or shear, and in such cases it is preferred that at least 30% of the pulp passing through the upper region (ie. the disturbance zone being 30% of the upper region), more preferably at least 50% of the pulp passing through the upper region (ie. the disturbance zone being 50% of the upper region) or even more preferably at least 70% of the pulp passing through the upper region (ie. the disturbance zone being 70% of the upper region) are disrupted in the disturbance zone 44.

However, the inventors believe that to maximise the efficiency of the shearing device and thus improve thickener performance, it is particularly preferred that at least 75% of the pulp passing through the upper region (the disturbance zone being 75% of the upper region) is subjected to the optimal disturbance or shear, more preferably 80%, even more preferably 90% and even yet more preferably 95% to 100% of the pulp passing through the upper region (the disturbance zone being 95% to 100% of the upper region) in order to obtain significant advantages in the use of the invention. This applies irrespective whether substantially uniform cumulative shear, substantially uniform average shear or a substantially uniform number of shear events, or any combination thereof, is applied in the disturbance zone.

In addition, while most of the preferred embodiments have been illustrated with two radial shearing arms for clarity, in other embodiments, the shearing devices have the illustrated picket configurations but with multiple shearing arms, for example, four, six and eight or more shearing arms, spaced apart (equidistantly or not) to apply shear substantially uniformly across the disturbance zone. In these embodiments, each shearing arm may apply shear to different portions of the disturbance zone. For example, a shearing device may have eight arms with shearing elements that are offset to each other so that while each arm only shears a portion of the upper region, the total effect of the shearing device is to apply shear in a disturbance zone that is substantially equal to the entire upper region.

Furthermore, it will be appreciated that the shearing device can be optionally controlled so that the average cumulative shear varies from a predetermined optimal shear value, either above or below. Throughout the description and claims, the term “average cumulative shear” means the average of the entire cumulative shear that is applied to the proportion of the pulp exiting the region. For example, where cumulative shear is applied to a cylindrical region, the average cumulative shear is the average of the cumulative shear taken over an area of a horizontal disc parallel to and adjacent the exit of the cylindrical region.

The inventors contemplate that the predetermined optimal shear value and any variation will depend on one or more parameters selected from the group consisting essentially of the speed of the shearing device, the shape of the shearing device, the depth of the shearing region, the pulp composition, the pulp particle size, the pulp flow velocity in the tank, the pulp yield stress, the pulp viscosity, the underflow specific gravity, the underflow weight per weight percentage, the rate at which flocculant is added to the feed material or suspension and the flux of the feed material or suspension from which the pulp settles. Thus, the average cumulative shear could vary and be substantially within 20% above or below the predetermined optimal shear value, 30% above or below the predetermined optimal, shear value, 40% above or below the predetermined optimal shear value, or even 50% above or below the predetermined optimal shear value.

It will be appreciated by one skilled in the art that in the invention decoupling movement of the shearing device from the movement of the rake assembly enables the shearing device to be moved at a different speed and/or direction to the rake assembly, for example, counter-rotating the shearing device with respect to the direction of rotation of the rake assembly. This creates a complex fluid motion and turbulence in the shear region that inhibits or hinders the formation of donuts around the shearing device and/or rake assembly and their respective drive shafts. Thus, donutting effects are reduced, minimised or prevented in the tank 1, enabling the separation device to establish and maintain a relatively high density of thickened pulp bed 2, thereby improving separation efficiency. In addition, the invention enables an optimal amount of shear, a substantially uniform cumulative shear, a substantially uniform average shear between shearing elements or a substantially uniform number of shear events, to be applied to the pulp to disrupt the networked pulp without applying too little or excessive shear. Thus, an optimal amount of trapped liquid is released that can escape upwardly to the clarified zone of liquor. As the pulp below the disturbance zone has a higher relative density, it has an increased packing density, thus enabling quicker settling and more pulp to be compacted in the pulp bed below the disturbance zone. As a consequence, the underflow density of the pulp bed is maximised and the maximum amount of dilute liquor can be recovered through the overflow launder. This effect is particularly advantageous where the shear is in a disturbance zone in the upper region of the pulp bed or networked pulp layer. As a consequence, the invention achieves significant efficiencies in performance and the amount of settled material that is obtained. In all these respects, the invention represents a practical and commercially significant improvement over the prior art.

Although the invention has been described with reference to specific examples, it will be appreciated by those skilled in the art that the invention may be embodied in many other forms.

1-100. (canceled)

101. A separation device for separating pulp from a feed material, the separation device comprising a tank for receiving then feed material, a rake assembly mounted for rotation within the tank to move pulp towards an outlet thereof and a shearing device for shearing pulp within the tank, the shearing device being mounted for movement independently of the rake assembly.

102. The separation device of claim 101, wherein the rake assembly is mounted to a first drive shaft for rotation about a first axis and the shearing device is mounted to a second drive shaft for rotation about a second axis.

103. The separation device of claim 102, wherein the shearing device counter-rotates with respect to the direction of rotation of the rake assembly.

104. The separation device of claim 102, wherein the second drive shaft is concentric to the first drive shaft.

105. The separation device of claim 101, wherein the rake assembly is mounted to a first drive shaft for rotation about a first axis and the shearing device is mounted to a second drive shaft for movement along or substantially parallel to the first axis.

106. The separation device of claim 105, wherein the shearing device slidably moves along or parallel to the first axis.

107. The separation device of claim 105, wherein the second drive shaft is concentric to the first drive shaft.

108. The separation device of claim 105, wherein the shearing device moves substantially vertically with respect to a pulp bed.

109. The separation device of claim 105, wherein the shearing device substantially reciprocates vertically.

110. The separation device of claim 102, wherein the first axis is a central axis of the tank.

111. The separation device of claim 102, wherein the separation device comprises a first drive mechanism for driving rotation of the first drive shaft and a second drive mechanism independent of the first drive mechanism for driving movement of the second shaft.

112. The separation device of claim 111, wherein the second drive mechanism is coaxial with the second drive shaft.

113. The separation device of claim 101, wherein one or more shearing parameters are controlled with respect to a flux of the feed material fed into the tank and/or one or more operational parameters to controllably apply an optimal shear to pulp passing through a region of the tank.

114. The separation device of claim 113, wherein the shearing parameters are selected from the group consisting of the speed of the shearing device, the shape of the shearing device and the depth of the shearing region, and wherein the operational parameters are selected from the group consisting of the pulp composition, the pulp particle size, the pulp flow velocity in the tank, the pulp yield stress, the pulp viscosity, the underflow specific gravity, the underflow weight per weight percentage and the rate at which flocculant is added to the feed material.

115. The separation device of claim 113, wherein one or more of the shearing parameters are adjustable in response to changes in the flux and/or one or more of the operational parameters.

116. The separation device of claim 101, wherein the shearing device applies shear substantially uniformly across a disturbance zone in an upper region of a networked layer of pulp that has formed from pulp aggregates settling towards the bottom of the tank, so as to disrupt the networked pulp in the disturbance zone within a predetermined period of time.

117. The separation device of claim 116, wherein the shearing device is movable at least partially within the disturbance zone such that a substantially uniform cumulative shear is applied to the networked pulp in the disturbance zone within the predetermined period of time.

118. The separation device of claim 116, wherein two or more shearing elements are spaced apart along at least one arm of the shearing device to define respective intervals therebetween, such that a substantially uniform average shear is applied in at least two intervals, along a line parallel to or coincident with the at least one arm.

19. The separation device of claim 116, wherein the shearing device applies a substantially uniform number of shear events to the networked pulp in the disturbance zone within the predetermined period of time.

120. The separation device of claim 101, wherein the shearing device comprises at least two shearing arms supported for movement within the disturbance zone and a plurality of shearing elements for applying shear to the networked pulp.

121. The separation device of claim 101, wherein the shearing device comprises at least one partially planar plate having a plurality of openings.

122. The separation device of claim 101, wherein the shearing device comprises a plurality of shearing elements arranged in a pattern.

123. Use of a device defined in claim 101.
